(19) United States
(12) Patent Application Publication
(10) Pub. No.: US 2021/0356698 A1
(43) Pub. Date: Nov. 18, 2021

(54) Optical Imaging Lens Assembly

(71) Applicant: ZHEJIANG SUNNY OPTICS CO.,LTD., Ningbo (CN)

(72) Inventors: Jiaying ZHANG, Ningbo (CN); Fujian DAI, Ningbo (CN); Liefeng ZHAO, Ningbo (CN)

(21) Appl. No.: 17/315,237

(22) Filed: May 7, 2021

(30) Foreign Application Priority Data
May 15, 2020 (CN) 202010413470.6

(51) Int. Cl. G02B 9/64; G02B 13/00; G02B 27/00

(52) U.S. Cl. CPC G02B 9/64; G02B 27/0025; G02B 13/0045

(57) ABSTRACT

The disclosure provides an optical imaging lens assembly, which sequentially includes, from an object side to an image side along an optical axis, a first lens, a second lens, a third lens, a fourth lens, a fifth lens, a sixth lens and a seventh lens with refractive power respectively, wherein TTL is a distance from an object-side surface of the first lens to an imaging surface of the optical imaging lens assembly on the optical axis, and ImgH is a half of a diagonal length of an effective pixel region of the optical imaging lens assembly, TTL and ImgH meet TTL/ImgH≤1.2; a total effective focal length f of the optical imaging lens assembly and an entrance pupil diameter (EPD) of the optical imaging lens assembly meet f/EPD≤1.8; Semi-FOV is a half of a maximum Field of view (FOV) of the optical imaging lens assembly, Semi-FOV and f meet f×tan(Semi-FOV)>4.6 mm.

### CROSS-REFERENCE TO RELATED PRESENT APPLICATION(S)

The present application claims priority to and the benefit of Chinese Patent Present invention No. 202010413470.6, filed in the China National Intellectual Property Administration (CNIPA) on 15 May 2020, which is incorporated herein by reference in its entirety.

### TECHNICAL FIELD

The disclosure relates to the field of optical elements, and particularly to an optical imaging lens assembly.

### BACKGROUND

With the rapid development of electronic products, optical imaging lens assemblies have been applied more and more extensively. On one hand, due to a trend of development of electronic products to light and thin designs, an optical imaging lens assembly is required to be high in image quality and light and thin in appearance, to effectively reduce the product cost and conform to a personalized design better. On the other hand, users also make higher requirements on the quality of images, shot by optical imaging lens assembly of electronic products, of objects. In addition, with the improvement of semiconductor process technologies, pixel sizes of photosensitive elements have been reduced constantly such that optical imaging lens assembly arranged in electronic products such as mobile phones or digital cameras have gradually tended to be developed to the fields of small size, large field of view (FOV), high resolution and the like.

At present, for achieving a high resolution and a large field of view, a large-aperture configuration is usually required to be adopted for a common optical imaging lens assembly on the market, resulting in a relatively great length of the lens, and thus it is difficult to meet a requirement of matching with a high-resolution photosensitive chip. In addition, further improving an FOV may usually result in a distortion increase, i.e., an excessively large chief ray emergence angle, and further make resolving power of the lens inadequate. For meeting a market development requirement, it is necessary to reduce a Total Track Length (TTL) of an optical imaging lens assembly as well as the number of lenses as much as possible. However, in this manner, the degree of freedom of design may also be reduced, more difficulties are brought to design, and a high-quality imaging requirement is unlikely to meet.

### SUMMARY

Some embodiments of the disclosure provide an optical imaging lens assembly, which sequentially includes, from an object side to an image side along an optical axis, a first lens, a second lens, a third lens, a fourth lens, a fifth lens, a sixth lens and a seventh lens with refractive power respectively, wherein TTL is a distance from an object-side surface of the first lens to an imaging surface of the optical imaging lens assembly on the optical axis, and ImgH is a half of a diagonal length of an effective pixel region of the optical imaging lens assembly, TTL and ImgH may meet TTL/ImgH≤1.2; a total effective focal length f of the optical imaging lens assembly and an entrance pupil diameter (EPD) of the optical imaging lens assembly may meet f/EPD≤1.8; Semi-FOV is a half of a maximum FOV of the optical imaging lens assembly, Semi-FOV and the total effective focal length f of the optical imaging lens assembly may meet f×tan(Semi-FOV)>4.6 mm.

In an implementation mode, the object-side surface of the first lens to an image-side surface of the seventh lens includes at least one aspheric mirror surface.

In an implementation mode, an effective focal length f1 of the first lens, a curvature radius R1 of the object-side surface of the first lens and a curvature radius R2 of an image-side surface of the first lens may meet 0.8<f1/(R1+R2)<1.3.

In an implementation mode, an effective focal length f2 of the second lens, a curvature radius R3 of an object-side surface of the second lens and a curvature radius R4 of an image-side surface of the second lens may meet −1.0<(R3+R4)/f2<−0.5.

In an implementation mode, an effective focal length f3 of the third lens and a curvature radius R5 of an object-side surface of the third lens may meet 0.3<R5/f3<0.8.

In an implementation mode, the total effective focal length f of the optical imaging lens assembly and a combined focal length f123 of the first lens, the second lens and the third lens may meet 0.8<f/f123<1.3.

In an implementation mode, an effective focal length f6 of the sixth lens, an effective focal length f7 of the seventh lens and a combined focal length f67 of the sixth lens and the seventh lens may meet 0.5<(f7−f6)/f67<1.0.

In an implementation mode, a curvature radius R11 of an object-side surface of the sixth lens, a curvature radius R12 of an image-side surface of the sixth lens, a curvature radius R13 of an object-side surface of the seventh lens and a curvature radius R14 of the image-side surface of the seventh lens may meet 0.7<(R13+R14)/(R11+R12)<1.2.

In an implementation mode, SAG71 is a distance from an intersection point of an object-side surface of the seventh lens and the optical axis to an effective radius vertex of the object-side surface of the seventh lens on the optical axis, and SAG72 is a distance from an intersection point of an image-side surface of the seventh lens and the optical axis to an effective radius vertex of the image-side surface of the seventh lens on the optical axis, SAG71 and SAG72 may meet 0.5<SAG72/SAG71<1.0.

In an implementation mode, SAG41 is a distance from an intersection point of an object-side surface of the fourth lens and the optical axis to an effective radius vertex of the object-side surface of the fourth lens on the optical axis, SAG42 is a distance from an intersection point of an image-side surface of the fourth lens and the optical axis to an effective radius vertex of the image-side surface of the fourth lens on the optical axis, and SAG62 is a distance from an intersection point of an image-side surface of the sixth lens and the optical axis to an effective radius vertex of the image-side surface of the sixth lens on the optical axis, SAG41 and SAG42 and SAG62 may meet 0.7<(SAG41+SAG42)/SAG62<1.2.

In an implementation mode, an edge thickness ET2 of the second lens and an edge thickness ET7 of the seventh lens may meet 0.3<ET2/ET7<0.8.

In an implementation mode, an edge thickness ET5 of the fifth lens and an edge thickness ET6 of the sixth lens may meet 0.5<ET5/ET6<1.0.

In an implementation mode, a center thickness CT1 of the first lens on the optical axis, a center thickness CT2 of the second lens on the optical axis, a center thickness CT3 of the third lens on the optical axis, a center thickness CT5 of the fifth lens on the optical axis, a center thickness CT6 of the sixth lens on the optical axis and a center thickness CT7 of the seventh lens on the optical axis may meet 0.8<(CT1+CT2+CT3)/(CT5+CT6+CT7)<1.3.

In an implementation mode, a center thickness CT4 of the fourth lens on the optical axis and a spacing distance T34 of the third lens and the fourth lens on the optical axis may meet 0.7<CT4/T34<1.2.

In an implementation mode, the first lens has a positive refractive power, the object-side surface thereof is a convex surface, while the image-side surface is a concave surface.

In an implementation mode, the second lens has a negative refractive power, the object-side surface thereof is a convex surface, while the image-side surface is a concave surface.

In an implementation mode, the object-side surface of the third lens is a convex surface.

In an implementation mode, the sixth lens has a positive refractive power, and the object-side surface thereof is a convex surface.

In an implementation mode, the seventh lens has a negative refractive power, the object-side surface thereof is a concave surface, while the image-side surface is a concave surface.

Another aspect of the disclosure provides an optical imaging lens assembly, which sequentially includes, from an object side to an image side along an optical axis: a first lens with a refractive power; a second lens with a refractive power; a third lens with a positive refractive power; a fourth lens with a refractive power; a fifth lens with a refractive power; a sixth lens with a refractive power, an image-side surface thereof being a convex surface; and a seventh lens with a refractive power, wherein TTL is a distance from an object-side surface of the first lens to an imaging surface of the optical imaging lens assembly on the optical axis, and ImgH is a half of a diagonal length of an effective pixel region of the optical imaging lens assembly, TTL and ImgH may meet TTL/ImgH≤1.2; and a total effective focal length f of the optical imaging lens assembly and an EPD of the optical imaging lens assembly may meet f/EPD≤1.8.

According to the disclosure, refractive power is configured reasonably, and optical parameters are optimized, so that the provided optical imaging lens assembly is applicable to a portable electronic product, light, thin, small and high in imaging quality.

### BRIEF DESCRIPTION OF THE DRAWINGS

Detailed descriptions made to unrestrictive implementation modes with reference to the following drawings are read to make the other characteristics, purposes and advantages of the disclosure more apparent.

FIG. 1 is a structure diagram of an optical imaging lens assembly according to embodiment 1 of the disclosure;

FIG. 2A to FIG. 2D show a longitudinal aberration curve, an astigmatism curve, a distortion curve and a lateral color curve of an optical imaging lens assembly according to embodiment 1 respectively;

FIG. 3 is a structure diagram of an optical imaging lens assembly according to embodiment 2 of the disclosure;

FIG. 4A to FIG. 4D show a longitudinal aberration curve, an astigmatism curve, a distortion curve and a lateral color curve of an optical imaging lens assembly according to embodiment 2 respectively;

FIG. 5 is a structure diagram of an optical imaging lens assembly according to embodiment 3 of the disclosure;

FIG. 6A to FIG. 6D show a longitudinal aberration curve, an astigmatism curve, a distortion curve and a lateral color curve of an optical imaging lens assembly according to embodiment 3 respectively;

FIG. 7 is a structure diagram of an optical imaging lens assembly according to embodiment 4 of the disclosure;

FIG. 8A to FIG. 8D show a longitudinal aberration curve, an astigmatism curve, a distortion curve and a lateral color curve of an optical imaging lens assembly according to embodiment 4 respectively;

FIG. 9 is a structure diagram of an optical imaging lens assembly according to embodiment 5 of the disclosure;

FIG. 10A to FIG. 10D show a longitudinal aberration curve, an astigmatism curve, a distortion curve and a lateral color curve of an optical imaging lens assembly according to embodiment 5 respectively;

FIG. 11 is a structure diagram of an optical imaging lens assembly according to embodiment 6 of the disclosure;

FIG. 12A to FIG. 12D show a longitudinal aberration curve, an astigmatism curve, a distortion curve and a lateral color curve of an optical imaging lens assembly according to embodiment 6 respectively;

FIG. 13 is a structure diagram of an optical imaging lens assembly according to embodiment 7 of the disclosure;

FIG. 14A to FIG. 14D show a longitudinal aberration curve, an astigmatism curve, a distortion curve and a lateral color curve of an optical imaging lens assembly according to embodiment 7 respectively;

FIG. 15 is a structure diagram of an optical imaging lens assembly according to embodiment 8 of the disclosure; and

FIG. 16A to FIG. 16D show a longitudinal aberration curve, an astigmatism curve, a distortion curve and a lateral color curve of an optical imaging lens assembly according to embodiment 8 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain” and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

An optical imaging lens assembly according to an exemplary implementation mode of the disclosure may include seven lenses with a refractive power, i.e., a first lens, a second lens, a third lens, a fourth lens, a fifth lens, a sixth lens and a seventh lens respectively. The seven lenses are sequentially arranged from an object side to an image side along an optical axis. In the first lens to the seventh lens, there may be a spacing distance between any two adjacent lenses.

In the exemplary implementation mode, the optical imaging lens assembly according to the disclosure may meet TTL/ImgH≤1.2, wherein TTL is a distance from an object-side surface of the first lens to an imaging surface of the optical imaging lens assembly on the optical axis, and ImgH is a half of a diagonal length of an effective pixel region of the optical imaging lens assembly. TTL/ImgH≤1.2 is met, so that a system is compact in structure and meets a miniaturization requirement, and the system may also be endowed with the characteristics of high resolution, large aperture and ultrathin design.

In the exemplary implementation mode, the optical imaging lens assembly according to the disclosure may meet f/EPD≤1.8, wherein f is a total effective focal length of the optical imaging lens assembly, and EPD is an entrance pupil diameter of the optical imaging lens assembly. f/EPD≤1.8 is met, so that the optical imaging lens assembly has a relatively large aperture, the luminous flux of the system may be improved, and an imaging effect in a dark environment may be enhanced.

In the exemplary implementation mode, the optical imaging lens assembly according to the disclosure may meet f×tan(Semi-FOV)>4.6 mm, wherein f is the total effective focal length of the optical imaging lens assembly, and Semi-FOV is a half of a maximum field of view of the optical imaging lens assembly. f×tan(Semi-FOV)>4.6 mm is met, so that a large-image-surface imaging effect of the system may be achieved.

In the exemplary implementation mode, the optical imaging lens assembly according to the disclosure may meet 0.8<f1/(R1+R2)<1.3, wherein f1 is an effective focal length of the first lens, R1 is a curvature radius of the object-side surface of the first lens, and R2 is a curvature radius of an image-side surface of the first lens. More specifically, f1, R1 and R2 may further meet 0.8<f1/(R1+R2)<1.2. 0.8<f1/(R1+R2)<1.3 is met, so that the refractive power of the first lens may be configured reasonably, the TTL of the system may be reduced, module miniaturization may be implemented, and meanwhile, the tolerance sensitivity of the system may be balanced.

In the exemplary implementation mode, the optical imaging lens assembly according to the disclosure may meet −1.0<(R3+R4)/f2<−0.5, wherein f2 is an effective focal length of the second lens, R3 is a curvature radius of an object-side surface of the second lens, and R4 is a curvature radius of an image-side surface of the second lens. More specifically, R3, R4 and f2 may further meet −0.8<(R3+R4)/f2<−0.5. −1.0<(R3+R4)/f2<−0.5 is met, so that a contribution of the second lens to a fifth-order spherical aberration of the system may be controlled effectively, and furthermore, a third-order spherical aberration generated by the lens is compensated to achieve high imaging quality of the system on the axis.

In the exemplary implementation mode, the optical imaging lens assembly according to the disclosure may meet 0.3<R5/f3<0.8, where f3 is an effective focal length of the third lens, and R5 is a curvature radius of an object-side surface of the third lens. More specifically, R5 and f3 may further meet 0.4<R5/f3<0.6. 0.3<R5/f3<0.8 is met, so that a deflection angle of an edge field of view at the third lens may be controlled, and the sensitivity of the system may be reduced effectively.

In the exemplary implementation mode, the optical imaging lens assembly according to the disclosure may meet 0.8<f/f123<1.3, wherein f is the total effective focal length of the optical imaging lens assembly, and f123 is a combined focal length of the first lens, the second lens and the third lens. More specifically, f and f123 may further meet 0.9<f/f123<1.1. 0.8<f/f123<1.3 is met, so that high imaging quality of the system is achieved, and a field curvature of the system may be controlled in a reasonable range.

In the exemplary implementation mode, the optical imaging lens assembly according to the disclosure may meet 0.5<(f7−f6)/f67<1.0, wherein f6 is an effective focal length of the sixth lens, f7 is an effective focal length of the seventh lens, and f67 is a combined focal length of the sixth lens and the seventh lens. More specifically, f7, f6 and f67 may further meet 0.7<(f7−f6)/f67<0.9. 0.5<(f7−f6)/f67<1.0 is met, so that contributions to aberrations of the sixth lens and the seventh lens may be controlled for balancing with an aberration generated by a front-end optical element, and a system aberration is in a reasonable level condition.

In the exemplary implementation mode, the optical imaging lens assembly according to the disclosure may meet 0.7<(R13+R14)/(R11+R12)<1.2, wherein R11 is a curvature radius of an object-side surface of the sixth lens, R12 is a curvature radius of an image-side surface of the sixth lens, R13 is a curvature radius of an object-side surface of the seventh lens, and R14 is a curvature radius of the image-side surface of the seventh lens. More specifically, R13, R14, R11 and R12 may further meet 0.8<(R13+R14)/(R11+R12)<1.0. Meeting 0.7<(R13+R14)/(R11+R12)<1.2 is favorable for balancing the system aberration and improving the imaging quality of the system.

In the exemplary implementation mode, the optical imaging lens assembly according to the disclosure may meet 0.5<SAG72/SAG71<1.0, wherein SAG71 is a distance from an intersection point of the object-side surface of the seventh lens and the optical axis to an effective radius vertex of the object-side surface of the seventh lens on the optical axis, and SAG72 is a distance from an intersection point of the image-side surface of the seventh lens and the optical axis to an effective radius vertex of the image-side surface of the seventh lens on the optical axis. More specifically, SAG72 and SAG71 may further meet 0.6<SAG72/SAG71<0.9. Meeting 0.5<SAG72/SAG71<1.0 is favorable for balancing a relationship between module miniaturization and relative illumination in an off-axis field of view better.

In the exemplary implementation mode, the optical imaging lens assembly according to the disclosure may meet 0.7<(SAG41+SAG42)/SAG62<1.2, wherein SAG41 is a distance from an intersection point of an object-side surface of the fourth lens and the optical axis to an effective radius vertex of the object-side surface of the fourth lens on the optical axis, SAG42 is a distance from an intersection point of an image-side surface of the fourth lens and the optical axis to an effective radius vertex of the image-side surface of the fourth lens on the optical axis, and SAG62 is a distance from an intersection point of the image-side surface of the sixth lens and the optical axis to an effective radius vertex of the image-side surface of the sixth lens on the optical axis. More specifically, SAG41, SAG42 and SAG62 may further meet 0.7<(SAG41+SAG42)/SAG62<1.0. 0.7<(SAG41+SAG42)/SAG62<1.2 is met, so that regulation of the field curvature of the system is facilitated, ghost images between the fourth lens and the sixth lens may be improved well, difficulties in machining may be reduced, and the optical imaging lens assembly is higher in assembling stability.

In the exemplary implementation mode, the optical imaging lens assembly according to the disclosure may meet 0.3<ET2/ET7<0.8, wherein ET2 is an edge thickness of the second lens, and ET7 is an edge thickness of the seventh lens. More specifically, ET2 and ET7 may further meet 0.4<ET2/ET7<0.6. Meeting 0.3<ET2/ET7<0.8 is favorable for controlling a distortion contribution of each field of view of the system in a reasonable range to finally make a system distortion less than 3% and improve the imaging quality.

In the exemplary implementation mode, the optical imaging lens assembly according to the disclosure may meet 0.5<ET5/ET6<1.0, wherein ET5 is an edge thickness of the fifth lens, and ET6 is an edge thickness of the sixth lens. More specifically, ET5 and ET6 may further meet 0.7<ET5/ET6<0.9. 0.5<ET5/ET6<1.0 is met, so that the system size may be reduced effectively, and high machinability of the optical element may be ensured.

In the exemplary implementation mode, the optical imaging lens assembly according to the disclosure may meet 0.8<(CT1+CT2+CT3)/(CT5+CT6+CT7)<1.3, wherein CT1 is a center thickness of the first lens on the optical axis, CT2 is a center thickness of the second lens on the optical axis, CT3 is a center thickness of the third lens on the optical axis, CT5 is a center thickness of the fifth lens on the optical axis, CT6 is a center thickness of the sixth lens on the optical axis, and CT7 is a center thickness of the seventh lens on the optical axis. More specifically, CT1, CT2, CT3, CT5, CT6 and CT7 may further meet 0.9<(CT1+CT2+CT3)/(CT5+CT6+CT7)<1.1. 0.8<(CT1+CT2+CT3)/(CT5+CT6+CT7)<1.3 is met, so that the field curvature of the system may be ensured effectively, furthermore, high imaging quality is achieved in the off-axis FOV of the system, the TTL of the system may be reduced effectively, and the characteristic of ultrathin design is achieved.

In the exemplary implementation mode, the optical imaging lens assembly according to the disclosure may meet 0.7<CT4/T34<1.2, wherein CT4 is a center thickness of the fourth lens on the optical axis, and T34 is a spacing distance of the third lens and the fourth lens on the optical axis. More specifically, CT4 and T34 may further meet 0.8<CT4/T34<1.1. 0.7<CT4/T34<1.2 is met, so that avoidance of generation of ghost images between the third lens and the fourth lens is facilitated, and the optical imaging lens assembly may be endowed with a better spherical aberration and distortion correction function.

In the exemplary implementation mode, the third lens may have a positive refractive power. Through the third lens with the positive refractive power, a light convergence capability may be improved, and improvement of the field curvature of the system and balancing of the system aberration are facilitated.

In the exemplary implementation mode, the image-side surface of the sixth lens may be a convex surface. Through the sixth lens of which the image-side surface is a convex surface, a ray incidence angle may be reduced effectively, large-angle light deflections may be avoided, and process machining is facilitated greatly.

In the exemplary implementation mode, the first lens may have a positive refractive power, the object-side surface thereof may be a convex surface, while the image-side surface may be a concave surface. The object-side surface of the first lens with the positive refractive power is a convex surface, while the image-side surface is a concave surface, so that improvement of the relative illumination in the off-axis field of view and enlargement of the field of view are facilitated.

In the exemplary implementation mode, the second lens may have a negative refractive power, the object-side surface thereof may be a convex surface, while the image-side surface may be a concave surface. The object-side surface of the second lens with the negative refractive power is a convex surface, while the image-side surface is a concave surface, so that control over a light angle and reduction of the system aberration are facilitated.

In the exemplary implementation mode, the object-side surface of the third lens may be a convex surface. Through the third lens of which the object-side surface is a convex surface, a high central ray convergence capability may be achieved, and the spherical aberration of the system may be improved.

In the exemplary implementation mode, the sixth lens may have a positive refractive power, and the object-side surface thereof may be a convex surface. The object-side surface of the sixth lens with the positive refractive power is a convex surface, so that enlargement of the FOV is facilitated, and meanwhile, reduction of a ray incidence angle at a position of a diaphragm, reduction of a pupil aberration and improvement of the imaging quality are also facilitated.

In the exemplary implementation mode, the seventh lens may have a negative refractive power, the object-side surface thereof may be a concave surface, while the image-side surface may be a concave surface. Through the seventh lens with the negative refractive power, the TTL of the system may be reduced effectively, and the characteristics of small size, ultrathin design and the like of the lens may be achieved.

In the exemplary implementation mode, the optical imaging lens assembly according to the disclosure may further include a diaphragm arranged between the object side and the first lens. Optionally, the optical imaging lens assembly may further include an optical filter configured to correct a chromatic aberration and/or protective glass configured to protect a photosensitive element on the imaging surface. The disclosure provides an optical imaging lens assembly with the characteristics of small size, large image surface, large aperture, ultrathin design, high imaging quality and the like. The optical imaging lens assembly according to the implementation mode of the disclosure may adopt multiple lenses, for example, the abovementioned seven lenses. The refractive power and surface types of each lens, the center thickness of each lens, on-axis distances between the lenses and the like may be reasonably configured to effectively converge incident light, reduce the TTL of the imaging lens, improve the machinability of the imaging lens and ensure that the optical imaging lens assembly is more favorable for production and machining.

In the implementation mode of the disclosure, at least one of mirror surfaces of each lens is an aspheric mirror surface, namely at least one mirror surface in the object-side surface of the first lens to an image-side surface of the seventh lens is an aspheric mirror surface. An aspheric lens has a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatic aberrations. With adoption of the aspheric lens, astigmatic aberrations during imaging may be eliminated as much as possible, thereby improving the imaging quality. Optionally, at least one of the object-side surface and image-side surface of each lens in the first lens, the second lens, the third lens, the fourth lens, the fifth lens, the sixth lens and the seventh lens is an aspheric mirror surface. Optionally, both the object-side surface and image-side surface of each lens in the first lens, the second lens, the third lens, the fourth lens, the fifth lens, the sixth lens and the seventh lens are aspheric mirror surfaces.

However, those skilled in the art should know that the number of the lenses forming the optical imaging lens assembly may be changed without departing from the technical solutions claimed in the disclosure to achieve each result and advantage described in the specification. For example, although descriptions are made in the implementation with seven lenses as an example, the optical imaging lens assembly is not limited to seven lenses. If necessary, the optical imaging lens assembly may further include another number of lenses.

Specific embodiments of the optical imaging lens assembly applied to the abovementioned implementation mode will further be described below with reference to the drawings.

### Embodiment 1

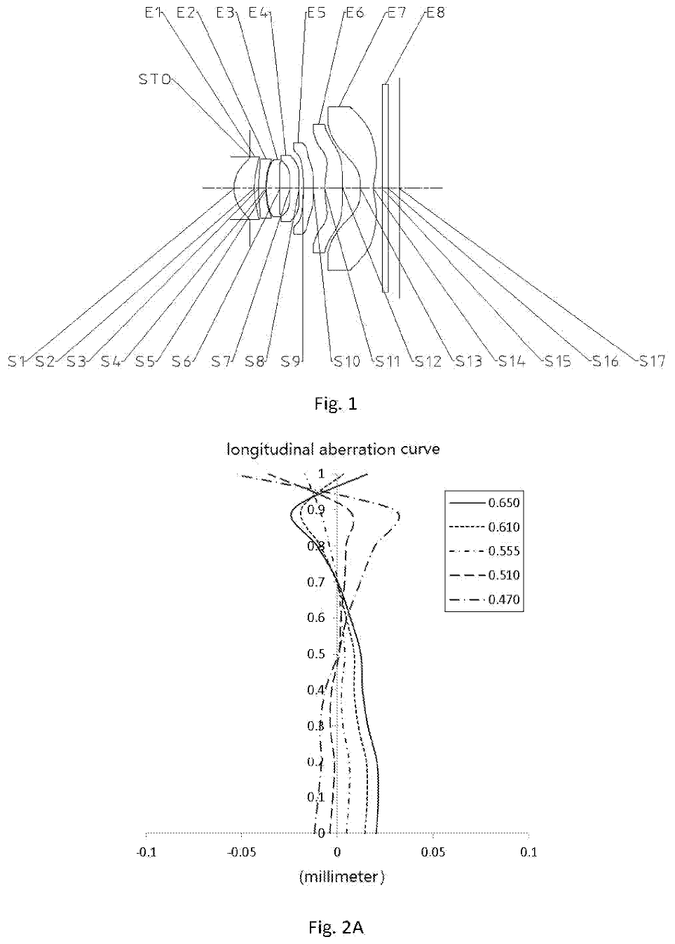

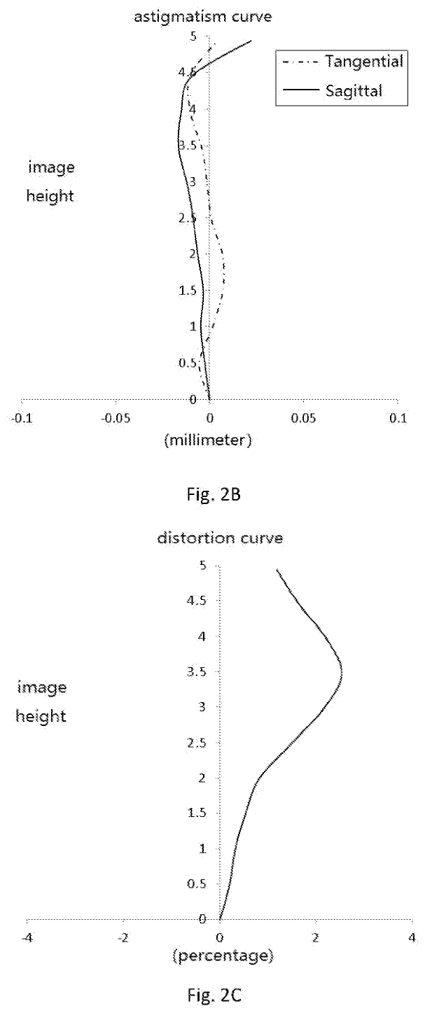

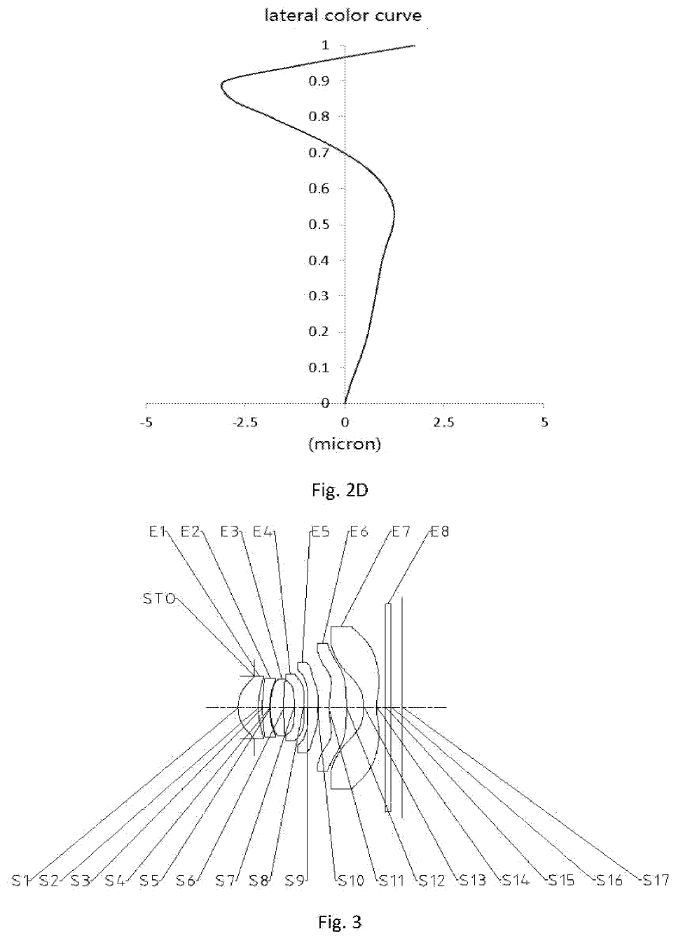

An optical imaging lens assembly according to embodiment 1 of the disclosure will be described below with reference to FIG. 1 to FIG. 2D. FIG. 1 is a structure diagram of an optical imaging lens assembly according to embodiment 1 of the disclosure.

As shown in FIG. 1, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a concave surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

Table 1 is a basic parameter table of the optical imaging lens assembly of embodiment 1, and units of the curvature radius, the thickness/distance and the focal length are all millimeter (mm).

TABLE 1

| | | | | Material | | | |
|---|---|---|---|---|---|---|---|
| Surface | | | Thickness/ | | Abbe | Focal | Conic |
| number | Surface type | Curvature radius | distance | Refractive index | number | length | coefficient |
| OBJ | Spherical | Infinite | Infinite | | | | |
| STO | Spherical | Infinite | −0.5544 | | | | |
| S1 | Aspheric | 1.8836 | 0.7033 | 1.55 | 56.1 | 5.33 | −0.2215 |
| S2 | Aspheric | 4.0192 | 0.1491 | | | | 0.5700 |
| S3 | Aspheric | 6.7658 | 0.2500 | 1.67 | 19.2 | −15.83 | −1.1374 |
| S4 | Aspheric | 4.0868 | 0.0338 | | | | 3.5678 |
| S5 | Aspheric | 5.8899 | 0.4617 | 1.55 | 56.1 | 10.21 | 6.9527 |
| S6 | Aspheric | −100.0000 | 0.3450 | | | | −99.0000 |
| S7 | Aspheric | −30.4023 | 0.3229 | 1.67 | 19.2 | −23.92 | 99.0000 |
| S8 | Aspheric | 34.8549 | 0.1395 | | | | −83.1575 |
| S9 | Aspheric | 24.1802 | 0.3522 | 1.57 | 38.0 | 114.09 | 48.8696 |
| S10 | Aspheric | 38.2733 | 0.3980 | | | | −99.0000 |
| S11 | Aspheric | 4.4907 | 0.6256 | 1.55 | 56.1 | 5.73 | 0.0084 |
| S12 | Aspheric | −9.7933 | 0.6125 | | | | 0.7679 |
| S13 | Aspheric | −6.9465 | 0.4501 | 1.54 | 55.9 | −3.08 | −0.0737 |
| S14 | Aspheric | 2.2170 | 0.3097 | | | | −0.9846 |
| S15 | Spherical | Infinite | 0.2100 | 1.52 | 64.2 | | |
| S16 | Spherical | Infinite | 0.3766 | | | | |
| S17 | Spherical | Infinite | | | | | |

In the example, a total effective focal length f of the optical imaging lens assembly is 4.92 mm, a TTL (i.e., a distance from the object-side surface S1 of the first lens E1 to the imaging surface S17 of the optical imaging lens assembly on an optical axis) of the optical imaging lens assembly is 5.74 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.9°, and a ratio f/EPD of the total effective focal length f of the optical imaging lens assembly to an EPD of the optical imaging lens assembly is 1.78.

In embodiment 1, both the object-side surface and image-side surface of any lens in the first lens E1 to the seventh lens E7 are aspheric surfaces, and a surface type x of each aspheric lens may be defined through, but not limited to, the following aspheric surface formula:

$$x = \frac{c {h}^{2}}{1 + \sqrt{1 - ( k + 1 ) {c}^{2} {h}^{2}}} + \sum {Aih}^{i} , \qquad ( 1 )$$

wherein x is a distance vector height from a vertex of the aspheric surface when the aspheric surface is at a height of h along the optical axis direction; c is a paraxial curvature of the aspheric surface, c=1/R (namely, the paraxial curvature c is a reciprocal of the curvature radius R in Table 1); k is a conic coefficient; and Ai is a correction coefficient of the i-th order of the aspheric surface. The following Tables 2-1 and 2-2 show high-order coefficients A₄, A₆, A₈, A₁₀, A₁₂, A₁₄, A₁₆, A₁₈, A₂₀, A₂₂, A₂₄, A₂₆, A₂₈ and A₃₀ applied to the aspheric mirror surfaces S1-S14 in embodiment 1.

TABLE 2-1

| Surface number | A4 | A6 | A8 | A10 | A12 | A14 | A16 |
|---|---|---|---|---|---|---|---|
| S1 | −4.6663E−03 | −7.9638E−03 | −2.8720E−03 | −5.9866E−04 | −5.1079E−05 | 5.5274E−05 | 3.2717E−05 |
| S2 | −6.9919E−02 | −1.3697E−03 | 2.5298E−03 | 1.2251E−03 | 5.3886E−04 | 2.1946E−04 | 9.6007E−05 |
| S3 | −7.0887E−02 | 1.1400E−02 | 1.0614E−03 | 3.6972E−04 | 3.1445E−04 | 6.5411E−05 | 4.0454E−05 |
| S4 | −3.2379E−02 | 4.4941E−06 | −4.4761E−03 | −3.0534E−03 | −9.3853E−04 | −1.3811E−04 | 2.4771E−04 |
| S5 | 5.3052E−02 | 1.7441E−02 | 6.4032E−03 | −4.0813E−04 | −8.7552E−04 | −4.0361E−04 | 6.2882E−05 |
| S6 | 1.3045E−04 | 1.0614E−02 | 6.2447E−03 | 2.4671E−03 | 9.7077E−04 | 3.1293E−04 | 1.1895E−04 |
| S7 | −2.2024E−01 | −2.5571E−02 | −5.2684E−04 | 1.0974E−03 | 7.0062E−04 | 2.3978E−04 | 6.3332E−05 |
| S8 | −3.3943E−01 | −6.5147E−03 | 1.3326E−02 | 7.9051E−03 | 2.3060E−03 | 3.0236E−04 | −2.2103E−04 |
| S9 | −3.8543E−01 | 1.6179E−02 | −2.3485E−02 | 8.4134E−03 | 7.3917E−03 | 3.0553E−03 | 5.1775E−04 |
| S10 | −4.7306E−01 | 1.2606E−01 | −7.7552E−02 | 3.6615E−03 | 5.0664E−03 | −3.9137E−03 | −1.1310E−03 |
| S11 | −1.3928E+00 | 2.6210E−01 | 3.0484E−02 | −5.3260E−02 | 5.7095E−03 | 8.6915E−03 | −4.0627E−03 |
| S12 | −2.9822E−01 | 9.4737E−02 | 4.3580E−02 | −4.0146E−02 | 1.6435E−02 | 1.9611E−03 | −2.6305E−03 |
| S13 | −8.4271E−01 | 6.5253E−01 | −3.0970E−01 | 1.3333E−01 | −3.9434E−02 | 1.2897E−02 | −4.4291E−03 |
| S14 | −4.5633E+00 | 9.4664E−01 | −3.4271E−01 | 1.7391E−01 | −7.1106E−02 | 2.9378E−02 | −1.7022E−02 |

TABLE 2-2

| Surface number | A18 | A20 | A22 | A24 | A26 | A28 | A30 |
|---|---|---|---|---|---|---|---|
| S1 | 1.6584E−05 | −3.8939E−06 | 0.0000E+00 | 0.0000E+00 | 0.0000E+00 | 0.0000E+00 | 0.0000E+00 |
| S2 | 3.9407E−05 | 7.3164E−06 | 0.0000E+00 | 0.0000E+00 | 0.0000E+00 | 0.0000E+00 | 0.0000E+00 |
| S3 | 1.2781E−05 | 1.9614E−07 | 0.0000E+00 | 0.0000E+00 | 0.0000E+00 | 0.0000E+00 | 0.0000E+00 |
| S4 | 1.7353E−04 | 3.5619E−05 | 0.0000E+00 | 0.0000E+00 | 0.0000E+00 | 0.0000E+00 | 0.0000E+00 |
| S5 | 1.0534E−04 | 2.2075E−05 | 0.0000E+00 | 0.0000E+00 | 0.0000E+00 | 0.0000E+00 | 0.0000E+00 |
| S6 | 2.8027E−05 | 1.3505E−05 | 0.0000E+00 | 0.0000E+00 | 0.0000E+00 | 0.0000E+00 | 0.0000E+00 |
| S7 | −3.4777E−06 | −5.5705E−06 | 7.6460E−08 | 0.0000E+00 | 0.0000E+00 | 0.0000E+00 | 0.0000E+00 |
| S8 | −2.1707E−04 | −7.2193E−05 | 0.0000E+00 | 0.0000E+00 | 0.0000E+00 | 0.0000E+00 | 0.0000E+00 |
| S9 | −2.3282E−04 | −2.5445E−04 | −3.2050E−04 | −1.7994E−04 | −5.5333E−05 | 0.0000E+00 | 0.0000E+00 |
| S10 | 1.2222E−03 | 4.5307E−04 | −1.0209E−04 | 2.4929E−04 | 1.9034E−04 | 0.0000E+00 | 0.0000E+00 |
| S11 | −4.5568E−03 | 1.2986E−03 | 7.2799E−04 | −7.2500E−04 | −3.9004E−04 | 1.0160E−04 | 3.9928E−06 |
| S12 | −4.6462E−03 | −6.6387E−04 | 1.2244E−03 | 8.5097E−04 | 2.4708E−04 | −9.9563E−05 | −2.7219E−04 |
| S13 | −1.9777E−03 | −1.2201E−03 | 3.0289E−03 | −4.9868E−04 | −3.3477E−04 | 2.9930E−05 | −2.8597E−05 |
| S14 | 9.1427E−03 | −2.4215E−03 | 3.7099E−03 | −9.4365E−04 | 8.2990E−04 | −5.2222E−04 | 6.2632E−05 |

FIG. 2A shows a longitudinal aberration curve of the optical imaging lens assembly according to embodiment 1 to represent deviation of a convergence focal point after light with different wavelengths passes through the lens. FIG. 2B shows an astigmatism curve of the optical imaging lens assembly according to embodiment 1 to represent a tangential image surface curvature and a sagittal image surface curvature. FIG. 2C shows a distortion curve of the optical imaging lens assembly according to embodiment 1 to represent distortion values corresponding to different image heights. FIG. 2D shows a lateral color curve of the optical imaging lens assembly according to embodiment 1 to represent deviation of different image heights on the imaging surface after the light passes through the lens. According to FIG. 2A to FIG. 2D, it can be seen that the optical imaging lens assembly provided in embodiment 1 may achieve high imaging quality.

### Embodiment 2

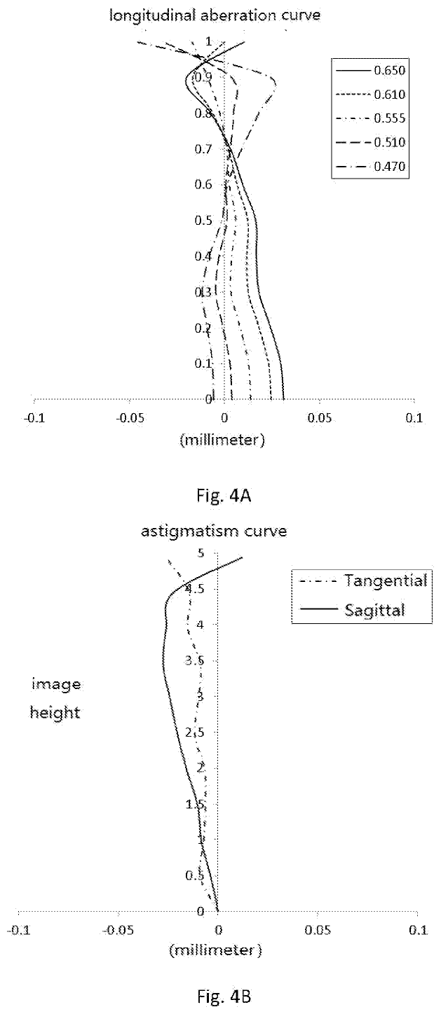

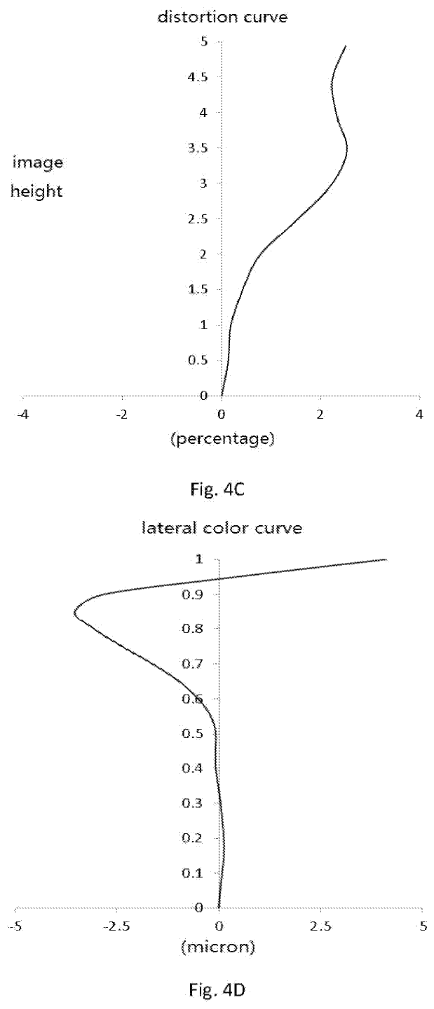

An optical imaging lens assembly according to embodiment 2 of the disclosure will be described below with reference to FIG. 3 to FIG. 4D. In the embodiment and the following embodiments, part of descriptions similar to those about embodiment is omitted for simplicity. FIG. 3 is a structure diagram of an optical imaging lens assembly according to embodiment 2 of the disclosure.

As shown in FIG. 3, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a negative refractive power, an object-side surface S7 thereof is a concave surface, while an image-side surface S8 is a convex surface. The fifth lens E5 has a negative refractive power, an object-side surface S9 thereof is a concave surface, while an image-side surface S10 is a concave surface. The sixth lens E6 has a positive refractive power, an object-side surface S11 thereof is a convex surface, and an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.92 mm, a TTL of the optical imaging lens assembly is 5.70 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.6°, and a ratio f/EPD of the total effective focal length f of the optical imaging lens assembly to an EPD of the optical imaging lens assembly is 1.78.

Table 3 is a basic parameter table of the optical imaging lens assembly of embodiment 2, and units of the curvature radius, the thickness/distance and the focal length are all millimeter (mm). Tables 4-1 and 4-2 show high-order coefficients applied to each aspheric mirror surface in embodiment 2. A surface type of each aspheric surface may be defined by formula (1) given in embodiment 1.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.5658 | | | | |
| S1 | Aspheric | 1.8674 | 0.7037 | 1.55 | 56.1 | 5.94 | −0.2124 |
| S2 | Aspheric | 3.8214 | 0.1406 | | | | 0.5866 |
| S3 | Aspheric | 5.9918 | 0.2500 | 1.67 | 19.2 | −14.90 | 0.5330 |
| S4 | Aspheric | 3.6972 | 0.0329 | | | | 3.3436 |
| S5 | Aspheric | 4.5387 | 0.4617 | 1.55 | 56.1 | 9.69 | 4.5780 |
| S6 | Aspheric | 30.7807 | 0.3662 | | | | −79.5811 |
| S7 | Aspheric | −24.5660 | 0.3420 | 1.67 | 19.2 | −44.49 | −99.0000 |
| S8 | Aspheric | −133.4174 | 0.1463 | | | | −99.0000 |
| S9 | Aspheric | −174.7033 | 0.3387 | 1.57 | 38.0 | −251.20 | −99.0000 |
| S10 | Aspheric | 797.2819 | 0.3836 | | | | −43.9435 |
| S11 | Aspheric | 4.5670 | 0.6041 | 1.55 | 56.1 | 5.73 | 0.0135 |
| S12 | Aspheric | −9.4674 | 0.5846 | | | | 1.0749 |
| S13 | Aspheric | −6.9462 | 0.4500 | 1.54 | 55.9 | −3.05 | −0.0611 |
| S14 | Aspheric | 2.1935 | 0.3094 | | | | −0.9880 |
| S15 | Spherical | Infinite | 0.2100 | 1.52 | 64.2 | | |
| S16 | Spherical | Infinite | 0.3763 | | | | |
| S17 | Spherical | Infinite | | | | | |

TABLE 4-1

| Surface number | A4 | A6 | A8 | A10 | A12 | A14 | A16 |
|---|---|---|---|---|---|---|---|
| S1 | −2.8222E−03 | −6.8704E−03 | −2.3101E−03 | −4.2425E−04 | 9.0636E−06 | 5.9946E−05 | 3.3056E−05 |
| S2 | −6.9522E−02 | −1.7675E−03 | 2.9336E−03 | 1.2002E−03 | 4.9406E−04 | 2.0396E−04 | 1.0040E−04 |
| S3 | −6.6904E−02 | 9.3125E−03 | 1.3685E−03 | 2.5325E−04 | 2.5904E−04 | 6.4104E−05 | 4.9390E−05 |
| S4 | −3.3149E−02 | −2.8118E−03 | −4.7595E−03 | −2.7899E−03 | −6.1099E−04 | −1.9203E−04 | 1.1513E−04 |
| S5 | 3.8122E−02 | 1.3596E−02 | 5.5872E−03 | 3.4404E−05 | −3.4352E−04 | −3.8383E−04 | −5.1939E−05 |
| S6 | −1.1807E−03 | 8.8502E−03 | 5.8317E−03 | 2.5384E−03 | 1.0035E−03 | 3.7140E−04 | 1.3567E−04 |
| S7 | −2.1149E−01 | −2.8076E−02 | −1.1323E−03 | 1.3203E−03 | 8.0812E−04 | 2.9935E−04 | 6.4487E−05 |
| S8 | −3.1529E−01 | −7.4775E−03 | 1.4452E−02 | 7.7806E−03 | 1.5657E−03 | −3.1633E−04 | −6.1322E−04 |
| S9 | −3.3353E−01 | 1.6898E−02 | −2.4463E−02 | 2.9311E−03 | 5.1893E−03 | 2.4352E−03 | 5.3763E−04 |
| S10 | −4.4565E−01 | 1.2709E−01 | −7.3003E−02 | 1.7104E−03 | 6.0358E−03 | −3.2311E−03 | −1.4988E−03 |
| S11 | −1.3793E+00 | 2.5461E−01 | 2.9303E−02 | −5.1376E−02 | 5.1985E−03 | 9.1058E−03 | −3.2491E−03 |
| S12 | −3.0073E−01 | 8.9544E−02 | 4.3954E−02 | −3.9663E−02 | 1.5751E−02 | 3.0698E−03 | −1.2677E−03 |
| S13 | −8.5177E−01 | 6.4305E−01 | −3.0417E−01 | 1.2795E−01 | −3.7399E−02 | 1.2558E−02 | −3.5501E−03 |
| S14 | −4.5785E+00 | 9.3922E−01 | −3.3372E−01 | 1.7172E−01 | −7.3817E−02 | 2.7734E−02 | −1.7886E−02 |

TABLE 4-2

| Surface number | A18 | A20 | A22 | A24 | A26 | A28 | A30 |
|---|---|---|---|---|---|---|---|
| S1 | 1.5518E−05 | −2.3191E−07 | 0.0000E+00 | 0.0000E+00 | 0.0000E+00 | 0.0000E+00 | 0.0000E+00 |
| S2 | 4.9341E−05 | 1.5823E−05 | 0.0000E+00 | 0.0000E+00 | 0.0000E+00 | 0.0000E+00 | 0.0000E+00 |
| S3 | 2.2399E−05 | 4.2057E−06 | 0.0000E+00 | 0.0000E+00 | 0.0000E+00 | 0.0000E+00 | 0.0000E+00 |
| S4 | 1.1158E−04 | 5.0970E−05 | 0.0000E+00 | 0.0000E+00 | 0.0000E+00 | 0.0000E+00 | 0.0000E+00 |
| S5 | 3.1423E−05 | 3.7023E−05 | 0.0000E+00 | 0.0000E+00 | 0.0000E+00 | 0.0000E+00 | 0.0000E+00 |
| S6 | 5.0268E−05 | 1.5740E−05 | 0.0000E+00 | 0.0000E+00 | 0.0000E+00 | 0.0000E+00 | 0.0000E+00 |
| S7 | −1.1160E−06 | −5.4112E−06 | 7.1938E−08 | 0.0000E+00 | 0.0000E+00 | 0.0000E+00 | 0.0000E+00 |
| S8 | −3.4486E−04 | −9.8778E−05 | 0.0000E+00 | 0.0000E+00 | 0.0000E+00 | 0.0000E+00 | 0.0000E+00 |
| S9 | 4.7459E−05 | 1.1557E−05 | −1.4123E−04 | −1.0455E−04 | −3.9927E−05 | 0.0000E+00 | 0.0000E+00 |
| S10 | 9.9911E−04 | 3.9482E−04 | −2.4610E−04 | 1.0218E−04 | 1.4788E−04 | 0.0000E+00 | 0.0000E+00 |
| S11 | −4.4112E−03 | 1.2560E−03 | 9.1411E−04 | −5.5508E−04 | −3.3152E−04 | 1.0902E−04 | 3.1413E−05 |
| S12 | −4.4851E−03 | −1.0750E−03 | 7.7997E−04 | 6.9885E−04 | 3.2517E−04 | 9.9115E−06 | −2.2143E−04 |
| S13 | −1.8122E−03 | −1.7351E−03 | 2.7742E−03 | −2.7786E−04 | −2.6252E−04 | 4.7216E−05 | −5.5125E−05 |
| S14 | 9.2897E−03 | −2.1291E−03 | 4.0650E−03 | −8.7391E−04 | 8.2778E−04 | −5.6217E−04 | 1.0486E−04 |

FIG. 4A shows a longitudinal aberration curve of the optical imaging lens assembly according to embodiment 2 to represent deviation of a convergence focal point after light with different wavelengths passes through the lens. FIG. 4B shows an astigmatism curve of the optical imaging lens assembly according to embodiment 2 to represent a tangential image surface curvature and a sagittal image surface curvature. FIG. 4C shows a distortion curve of the optical imaging lens assembly according to embodiment 2 to represent distortion values corresponding to different image heights. FIG. 4D shows a lateral color curve of the optical imaging lens assembly according to embodiment 2 to represent deviation of different image heights on the imaging surface after the light passes through the lens. According to FIG. 4A to FIG. 4D, it can be seen that the optical imaging lens assembly provided in embodiment 2 may achieve high imaging quality.

### Embodiment 3

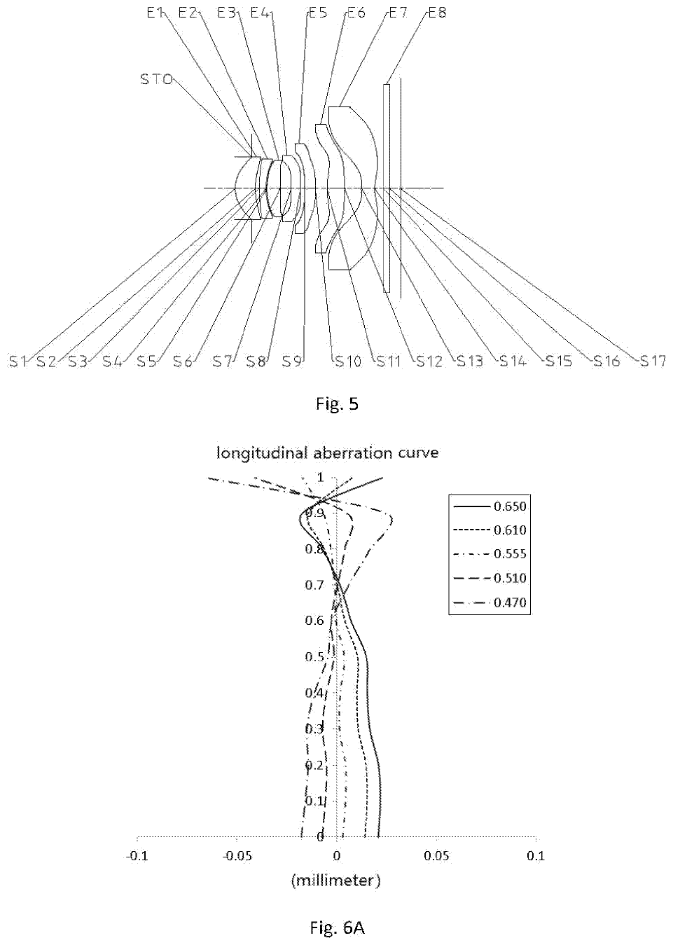

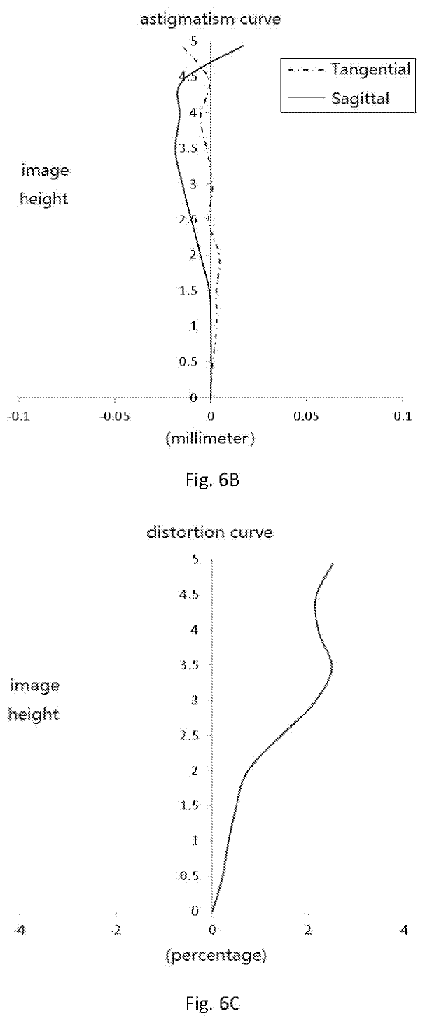

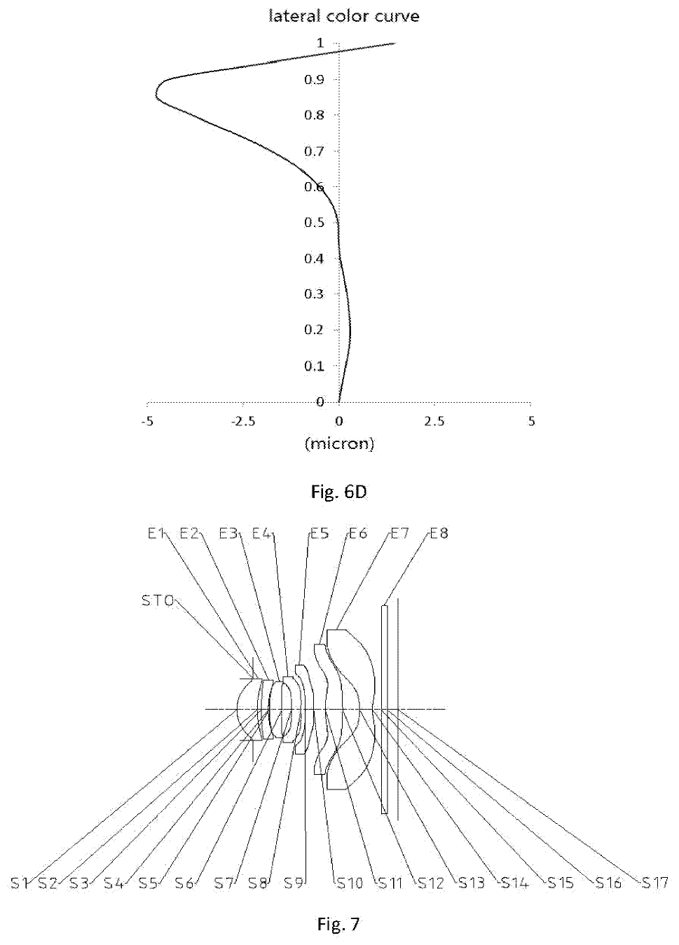

An optical imaging lens assembly according to embodiment 3 of the disclosure is described below with reference to FIG. 5 to FIG. 6D. FIG. 5 is a structure diagram of an optical imaging lens assembly according to embodiment 3 of the disclosure.

As shown in FIG. 5, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a negative refractive power, an object-side surface S7 thereof is a concave surface, while an image-side surface S8 is a concave surface. The fifth lens E5 has a positive refractive power, an object-side surface S9 thereof is a convex surface, while an image-side surface S10 is a convex surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.93 mm, a TTL of the optical imaging lens assembly is 5.74 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.5°, and a ratio f/EPD of the total effective focal length f of the optical imaging lens assembly to an EPD of the optical imaging lens assembly is 1.78.

Table 5 is a basic parameter table of the optical imaging lens assembly of embodiment 3, and units of the curvature radius, the thickness/distance and the focal length are all millimeter (mm). Tables 6-1 and 6-2 show high-order coefficients applied to each aspheric mirror surface in embodiment 3. A surface type of each aspheric surface may be defined by formula (1) given in embodiment 1.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.5650 | | | | |
| S1 | Aspheric | 1.8630 | 0.6966 | 1.55 | 56.1 | 6.15 | −0.2172 |
| S2 | Aspheric | 3.6303 | 0.1279 | | | | 0.1271 |
| S3 | Aspheric | 5.4971 | 0.2500 | 1.67 | 19.2 | −17.56 | 0.9134 |
| S4 | Aspheric | 3.6910 | 0.0336 | | | | 3.5342 |
| S5 | Aspheric | 4.5866 | 0.4574 | 1.55 | 56.1 | 10.00 | 4.9599 |
| S6 | Aspheric | 27.6786 | 0.3777 | | | | −99.0000 |
| S7 | Aspheric | −20.6078 | 0.3352 | 1.67 | 19.2 | −25.83 | −11.8658 |
| S8 | Aspheric | 116.9371 | 0.1357 | | | | 99.0000 |
| S9 | Aspheric | 133.7513 | 0.3745 | 1.57 | 38.0 | 74.12 | 99.0000 |
| S10 | Aspheric | −61.7530 | 0.3993 | | | | 11.0777 |
| S11 | Aspheric | 4.6270 | 0.6094 | 1.55 | 56.1 | 5.80 | 0.0120 |
| S12 | Aspheric | −9.5769 | 0.5983 | | | | 0.8632 |
| S13 | Aspheric | −6.8591 | 0.4500 | 1.54 | 55.9 | −3.05 | −0.0508 |
| S14 | Aspheric | 2.2038 | 0.3088 | | | | −0.9859 |
| S15 | Spherical | Infinite | 0.2100 | 1.52 | 64.2 | | |
| S16 | Spherical | Infinite | 0.3756 | | | | |
| S17 | Spherical | Infinite | | | | | |

TABLE 6-1

| Surface number | A4 | A6 | A8 | A10 | A12 | A14 | A16 |
|---|---|---|---|---|---|---|---|
| S1 | −4.0042E−03 | −8.5854E−03 | −3.0835E−03 | −6.6762E−04 | −3.6964E−05 | 6.1329E−05 | 3.9315E−05 |
| S2 | −7.5323E−02 | −2.2340E−03 | 3.3599E−03 | 1.3979E−03 | 6.0703E−04 | 2.4003E−04 | 1.2482E−04 |
| S3 | −6.8560E−02 | 1.2350E−02 | 2.2696E−03 | 5.4016E−04 | 4.3660E−04 | 1.1027E−04 | 7.3511E−05 |
| S4 | −2.9497E−02 | 1.8727E−04 | −3.8116E−03 | −2.7223E−03 | −5.4733E−04 | −2.1215E−04 | 1.0758E−04 |
| S5 | 4.0430E−02 | 1.3788E−02 | 5.9855E−03 | 1.2118E−05 | −3.1027E−04 | −3.7337E−04 | −3.4669E−05 |
| S6 | 4.2419E−03 | 8.3915E−03 | 5.5406E−03 | 2.4238E−03 | 9.5629E−04 | 3.5578E−04 | 1.3495E−04 |
| S7 | −2.1166E−01 | −2.6838E−02 | −1.0097E−03 | 1.3969E−03 | 7.8037E−04 | 2.8097E−04 | 6.1433E−05 |
| S8 | −3.3020E−01 | −5.9049E−03 | 1.1813E−02 | 7.6778E−03 | 1.3747E−03 | −1.5758E−04 | −5.2561E−04 |
| S9 | −3.3645E−01 | 1.9993E−02 | −2.6781E−02 | 1.4374E−03 | 3.0200E−03 | 2.2611E−03 | 6.3460E−04 |
| S10 | −4.2797E−01 | 1.2443E−01 | −7.3463E−02 | 1.3920E−03 | 5.8446E−03 | −2.7150E−03 | −1.5388E−03 |
| S11 | −1.3819E+00 | 2.5786E−01 | 3.0242E−02 | −5.0905E−02 | 5.6142E−03 | 8.6629E−03 | −3.7438E−03 |
| S12 | −2.9909E−01 | 9.8569E−02 | 4.3513E−02 | −4.1229E−02 | 1.6799E−02 | 1.9397E−03 | −3.0499E−03 |
| S13 | −8.5272E−01 | 6.4716E−01 | −3.0869E−01 | 1.3206E−01 | −3.9034E−02 | 1.2822E−02 | −3.9997E−03 |
| S14 | −4.5937E+00 | 9.4417E−01 | −3.4542E−01 | 1.7549E−01 | −7.4178E−02 | 2.7291E−02 | −1.7136E−02 |

TABLE 6-2

| Surface number | A18 | A20 | A22 | A24 | A26 | A28 | A30 |
|---|---|---|---|---|---|---|---|
| S1 | 1.8998E−05 | −3.5394E−07 | 0.0000E+00 | 0.0000E+00 | 0.0000E+00 | 0.0000E+00 | 0.0000E+00 |
| S2 | 6.5727E−05 | 2.6097E−05 | 0.0000E+00 | 0.0000E+00 | 0.0000E+00 | 0.0000E+00 | 0.0000E+00 |
| S3 | 3.5386E−05 | 8.7544E−06 | 0.0000E+00 | 0.0000E+00 | 0.0000E+00 | 0.0000E+00 | 0.0000E+00 |
| S4 | 1.0867E−04 | 4.9945E−05 | 0.0000E+00 | 0.0000E+00 | 0.0000E+00 | 0.0000E+00 | 0.0000E+00 |
| S5 | 4.3551E−05 | 3.7359E−05 | 0.0000E+00 | 0.0000E+00 | 0.0000E+00 | 0.0000E+00 | 0.0000E+00 |
| S6 | 5.1911E−05 | 1.6367E−05 | 0.0000E+00 | 0.0000E+00 | 0.0000E+00 | 0.0000E+00 | 0.0000E+00 |
| S7 | −3.6165E−06 | −6.6722E−06 | 6.7219E−08 | 0.0000E+00 | 0.0000E+00 | 0.0000E+00 | 0.0000E+00 |
| S8 | −3.0417E−04 | −1.1261E−04 | 0.0000E+00 | 0.0000E+00 | 0.0000E+00 | 0.0000E+00 | 0.0000E+00 |
| S9 | 3.0633E−04 | 1.0587E−04 | 6.6104E−06 | −5.8791E−05 | −1.1127E−05 | 0.0000E+00 | 0.0000E+00 |
| S10 | 1.0694E−03 | 4.5737E−04 | −1.0593E−04 | 1.0659E−04 | 1.6308E−04 | 0.0000E+00 | 0.0000E+00 |
| S11 | −4.1121E−03 | 1.3458E−03 | 8.3759E−04 | −5.7029E−04 | −2.9547E−04 | 1.1306E−04 | 2.8485E−05 |
| S12 | −4.6471E−03 | −4.1118E−04 | 1.4280E−03 | 8.8354E−04 | 2.1917E−04 | −8.8136E−05 | −2.6708E−04 |
| S13 | −1.8623E−03 | −1.2801E−03 | 2.9760E−03 | −4.4844E−04 | −3.3877E−04 | 4.5377E−05 | −5.5440E−05 |
| S14 | 9.3938E−03 | −2.1224E−03 | 3.9665E−03 | −9.2441E−04 | 8.8245E−04 | −5.3852E−04 | 7.7326E−05 |

FIG. 6A shows a longitudinal aberration curve of the optical imaging lens assembly according to embodiment 3 to represent deviation of a convergence focal point after light with different wavelengths passes through the lens. FIG. 6B shows an astigmatism curve of the optical imaging lens assembly according to embodiment 3 to represent a tangential image surface curvature and a sagittal image surface curvature. FIG. 6C shows a distortion curve of the optical imaging lens assembly according to embodiment 3 to represent distortion values corresponding to different image heights. FIG. 6D shows a lateral color curve of the optical imaging lens assembly according to embodiment 3 to represent deviation of different image heights on the imaging surface after the light passes through the lens. According to FIG. 6A to FIG. 6D, it can be seen that the optical imaging lens assembly provided in embodiment 3 may achieve high imaging quality.

### Embodiment 4

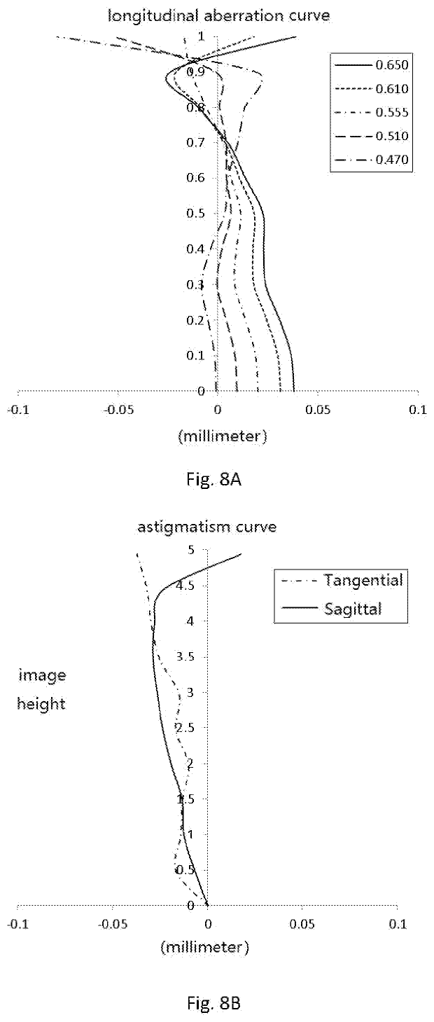

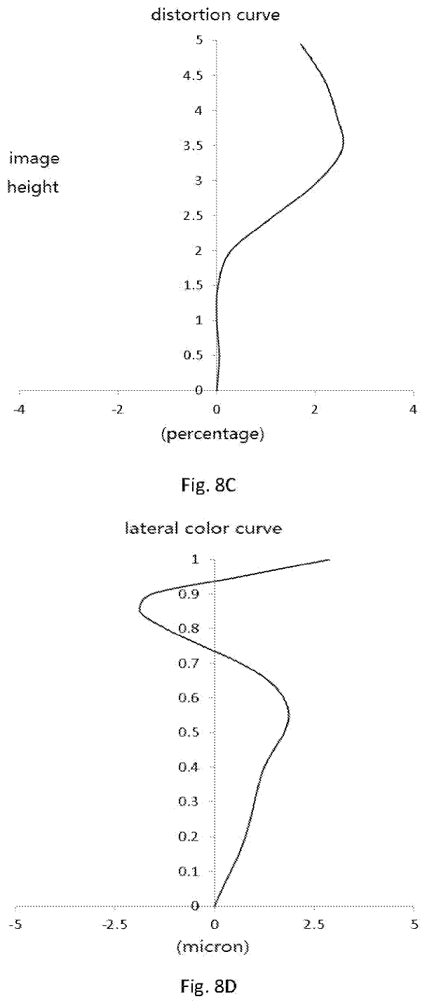

An optical imaging lens assembly according to embodiment 4 of the disclosure is described below with reference to FIG. 7 to FIG. 8D. FIG. 7 is a structure diagram of an optical imaging lens assembly according to embodiment 4 of the disclosure.

As shown in FIG. 7, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, and an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.92 mm, a TTL of the optical imaging lens assembly is 5.60 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.8°, and a ratio f/EPD of the total effective focal length f of the optical imaging lens assembly to an EPD of the optical imaging lens assembly is 1.80.

Table 7 is a basic parameter table of the optical imaging lens assembly of embodiment 4, and units of the curvature radius, the thickness/distance and the focal length are all millimeter (mm). Tables 8-1 and 8-2 show high-order coefficients applied to each aspheric mirror surface in embodiment 4. A surface type of each aspheric surface may be defined by formula (1) given in embodiment 1.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.5645 | | | | |
| S1 | Aspheric | 1.8134 | 0.7069 | 1.55 | 56.1 | 5.69 | −0.2287 |
| S2 | Aspheric | 3.7539 | 0.1408 | | | | 0.4308 |
| S3 | Aspheric | 6.3306 | 0.2500 | 1.67 | 19.2 | −17.60 | 0.4683 |
| S4 | Aspheric | 4.0692 | 0.0300 | | | | 3.4150 |
| S5 | Aspheric | 5.8354 | 0.4414 | 1.55 | 56.1 | 10.50 | 7.4754 |
| S6 | Aspheric | −320.0000 | 0.3284 | | | | 99.0000 |
| S7 | Aspheric | −29.0199 | 0.3314 | 1.67 | 19.2 | −25.83 | 98.1221 |
| S8 | Aspheric | 44.2978 | 0.1402 | | | | −99.0000 |
| S9 | Aspheric | 24.9902 | 0.3000 | 1.57 | 38.0 | −1080.30 | −28.8224 |
| S10 | Aspheric | 23.9115 | 0.4046 | | | | −56.7158 |
| S11 | Aspheric | 4.4760 | 0.6000 | 1.55 | 56.1 | 5.77 | 0.0671 |
| S12 | Aspheric | −10.1263 | 0.5872 | | | | 0.5343 |
| S13 | Aspheric | −6.8386 | 0.4500 | 1.54 | 55.9 | −3.01 | −0.0959 |
| S14 | Aspheric | 2.1681 | 0.3061 | | | | −0.9892 |
| S15 | Spherical | Infinite | 0.2100 | 1.52 | 64.2 | | |
| S16 | Spherical | Infinite | 0.3730 | | | | |
| S17 | Spherical | Infinite | | | | | |

TABLE 8-1

| Surface | | | | | | | |
|---|---|---|---|---|---|---|---|
| number | A4 | A6 | A8 | A10 | A12 | A14 | A16 |
| S1 | −4.1813E−03 | −1.0046E−02 | −4.0537E−03 | −9.9203E−04 | −1.1953E−04 | 6.3765E−05 | 5.2451E−05 |
| S2 | −7.3632E−02 | −2.1513E−03 | 2.9867E−03 | 1.5688E−03 | 5.3717E−04 | 1.8115E−04 | 6.6777E−05 |
| S3 | −6.9506E−02 | 1.5549E−02 | 2.2192E−03 | 6.9860E−04 | 2.6246E−04 | 2.5356E−05 | 1.2257E−05 |
| S4 | −2.7121E−02 | 3.8394E−03 | −3.5605E−03 | −2.7892E−03 | −1.1539E−03 | −2.6500E−04 | 1.7835E−04 |
| S5 | 4.9177E−02 | 1.5706E−02 | 6.0571E−03 | −9.7068E−05 | −8.8756E−04 | −4.6960E−04 | 9.9876E−06 |
| S6 | 4.6884E−03 | 8.8612E−03 | 5.2121E−03 | 2.0451E−03 | 8.3754E−04 | 2.8278E−04 | 1.2217E−04 |
| S7 | −2.0002E−01 | −2.3439E−02 | −6.5557E−04 | 4.6569E−04 | 3.9190E−04 | 8.8462E−05 | 3.2251E−05 |
| S8 | −3.2075E−01 | −2.4137E−03 | 1.3677E−02 | 6.2488E−03 | 1.4030E−03 | −3.2772E−05 | −3.3147E−04 |
| S9 | −3.7427E−01 | 1.7190E−02 | −2.6323E−02 | 3.4280E−03 | 5.3297E−03 | 2.8571E−03 | 8.8558E−04 |
| S10 | −4.6576E−01 | 1.1682E−01 | −7.1945E−02 | 6.1464E−03 | 3.9460E−03 | −3.5861E−03 | −8.1770E−04 |
| S11 | −1.3951E+00 | 2.6438E−01 | 2.8624E−02 | −5.3689E−02 | 7.1487E−03 | 8.4977E−03 | −4.5696E−03 |
| S12 | −2.9643E−01 | 1.0402E−01 | 4.3935E−02 | −4.2442E−02 | 1.7224E−02 | 5.2415E−04 | −4.2069E−03 |
| S13 | −8.4495E−01 | 6.5177E−01 | −3.1308E−01 | 1.3508E−01 | −4.0642E−02 | 1.3038E−02 | −4.7038E−03 |
| S14 | −4.5826E+00 | 9.4005E−01 | −3.4258E−01 | 1.7610E−01 | −7.3095E−02 | 2.6336E−02 | −1.6990E−02 |

TABLE 8-2

| Surface | | | | | | | |
|---|---|---|---|---|---|---|---|
| number | A18 | A20 | A22 | A24 | A26 | A28 | A30 |
| S1 | 2.3373E−05 | −4.5424E−06 | 0.0000E+00 | 0.0000E+00 | 0.0000E+00 | 0.0000E+00 | 0.0000E+00 |
| S2 | 3.2664E−05 | 5.0410E−06 | 0.0000E+00 | 0.0000E+00 | 0.0000E+00 | 0.0000E+00 | 0.0000E+00 |
| S3 | 5.8636E−06 | −3.8027E−07 | 0.0000E+00 | 0.0000E+00 | 0.0000E+00 | 0.0000E+00 | 0.0000E+00 |
| S4 | 1.6559E−04 | 3.9630E−05 | 0.0000E+00 | 0.0000E+00 | 0.0000E+00 | 0.0000E+00 | 0.0000E+00 |
| S5 | 9.3148E−05 | 2.5952E−05 | 0.0000E+00 | 0.0000E+00 | 0.0000E+00 | 0.0000E+00 | 0.0000E+00 |
| S6 | 3.7238E−05 | 1.7127E−05 | 0.0000E+00 | 0.0000E+00 | 0.0000E+00 | 0.0000E+00 | 0.0000E+00 |
| S7 | −4.9004E−06 | −9.1768E−07 | 4.4708E−08 | 0.0000E+00 | 0.0000E+00 | 0.0000E+00 | 0.0000E+00 |
| S8 | −2.5643E−04 | −9.3568E−05 | 0.0000E+00 | 0.0000E+00 | 0.0000E+00 | 0.0000E+00 | 0.0000E+00 |
| S9 | 1.2401E−04 | 2.6123E−05 | −1.5955E−04 | −1.3185E−04 | −6.2559E−05 | 0.0000E+00 | 0.0000E+00 |
| S10 | 9.1164E−04 | 2.0554E−04 | −1.7956E−04 | 1.8993E−04 | 1.2787E−04 | 0.0000E+00 | 0.0000E+00 |
| S11 | −4.0519E−03 | 1.6900E−03 | 6.1657E−04 | −7.5230E−04 | −2.3526E−04 | 1.6030E−04 | 4.3770E−05 |
| S12 | −4.4311E−03 | 1.6366E−04 | 1.8274E−03 | 8.7246E−04 | 1.3503E−04 | −3.1714E−04 | −2.6588E−04 |
| S13 | −2.0593E−03 | −8.7803E−04 | 3.1678E−03 | −5.4121E−04 | −4.1366E−04 | 1.2550E−04 | −1.2685E−04 |
| S14 | 8.8510E−03 | −1.7352E−03 | 4.0242E−03 | −5.5877E−04 | 8.6217E−04 | −5.6866E−04 | −4.3728E−06 |

FIG. 8A shows a longitudinal aberration curve of the optical imaging lens assembly according to embodiment 4 to represent deviation of a convergence focal point after light with different wavelengths passes through the lens. FIG. 8B shows an astigmatism curve of the optical imaging lens assembly according to embodiment 4 to represent a tangential image surface curvature and a sagittal image surface curvature. FIG. 8C shows a distortion curve of the optical imaging lens assembly according to embodiment 4 to represent distortion values corresponding to different image heights. FIG. 8D shows a lateral color curve of the optical imaging lens assembly according to embodiment 4 to represent deviation of different image heights on the imaging surface after the light passes through the lens. According to FIG. 8A to FIG. 8D, it can be seen that the optical imaging lens assembly provided in embodiment 4 may achieve high imaging quality.

### Embodiment 5

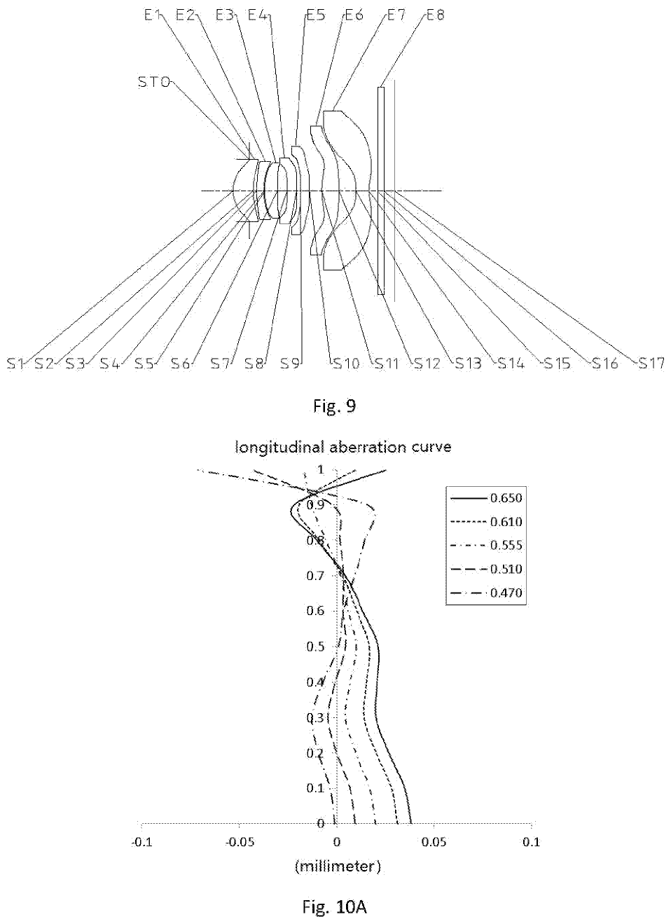

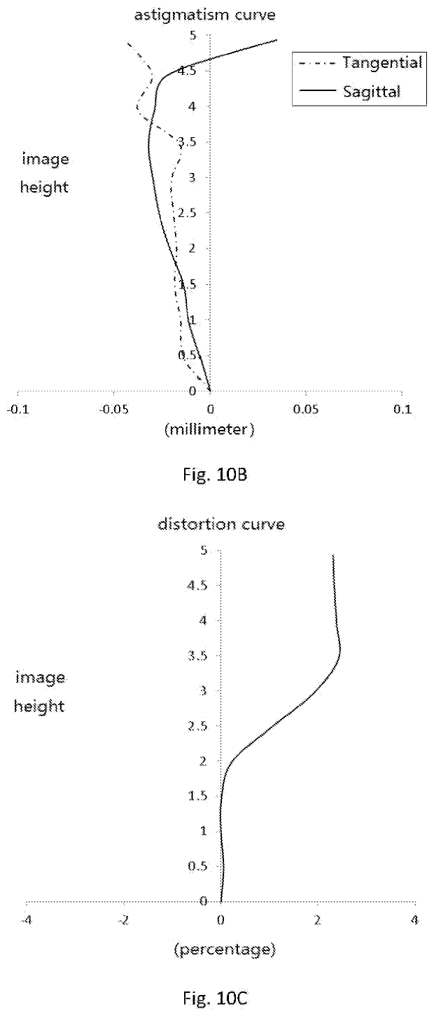

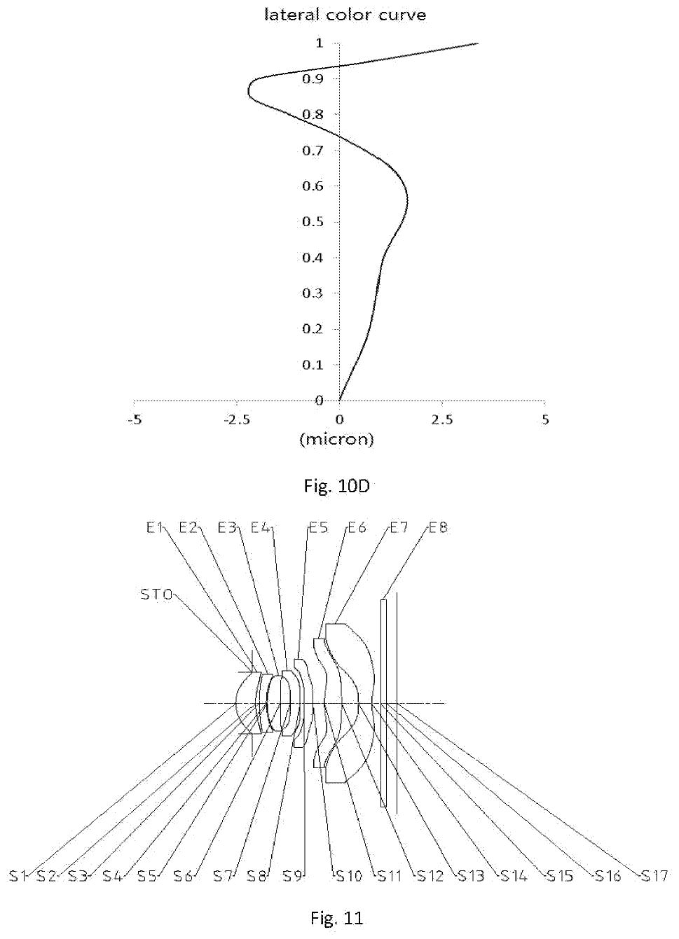

An optical imaging lens assembly according to embodiment 5 of the disclosure is described below with reference to FIG. 9 to FIG. 10D. FIG. 9 is a structure diagram of an optical imaging lens assembly according to embodiment 5 of the disclosure.

As shown in FIG. 9, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a negative refractive power, an object-side surface S7 thereof is a convex surface, while an image-side surface S8 is a concave surface. The fifth lens E5 has a positive refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.92 mm, a TTL of the optical imaging lens assembly is 5.60 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.6°, and a ratio f/EPD of the total effective focal length f of the optical imaging lens assembly to an EPD of the optical imaging lens assembly is 1.80.

Table 9 is a basic parameter table of the optical imaging lens assembly of embodiment 5, and units of the curvature radius, the thickness/distance and the focal length are all millimeter (mm). Tables 10-1 and 10-2 show high-order coefficients applied to each aspheric mirror surface in embodiment 5. A surface type of each aspheric surface may be defined by formula (1) given in embodiment 1.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.5645 | | | | |
| S1 | Aspheric | 1.8138 | 0.6924 | 1.55 | 56.1 | 6.05 | −0.2279 |
| S2 | Aspheric | 3.4832 | 0.1267 | | | | 0.2100 |
| S3 | Aspheric | 5.4579 | 0.2500 | 1.67 | 19.2 | −16.96 | 1.9178 |
| S4 | Aspheric | 3.6323 | 0.0300 | | | | 3.3029 |
| S5 | Aspheric | 4.4233 | 0.4420 | 1.55 | 56.1 | 10.23 | 5.4109 |
| S6 | Aspheric | 20.5160 | 0.3285 | | | | −16.4832 |
| S7 | Aspheric | 1,087.1851 | 0.3295 | 1.67 | 19.2 | −25.99 | 99.0000 |
| S8 | Aspheric | 17.3288 | 0.1400 | | | | −99.0000 |
| S9 | Aspheric | 14.7585 | 0.3114 | 1.57 | 38.0 | 84.75 | −99.0000 |
| S10 | Aspheric | 21.0815 | 0.4228 | | | | −98.9197 |
| S11 | Aspheric | 4.4951 | 0.6000 | 1.55 | 56.1 | 5.78 | 0.0492 |
| S12 | Aspheric | −10.0678 | 0.5888 | | | | 0.5747 |
| S13 | Aspheric | −6.8328 | 0.4500 | 1.54 | 55.9 | −3.01 | 0.0022 |
| S14 | Aspheric | 2.1642 | 0.3055 | | | | −0.9900 |
| S15 | Spherical | Infinite | 0.2100 | 1.52 | 64.2 | | |
| S16 | Spherical | Infinite | 0.3723 | | | | |
| S17 | Spherical | Infinite | | | | | |

TABLE 10-1

| Surface | | | | | | | |
|---|---|---|---|---|---|---|---|
| number | A4 | A6 | A8 | A10 | A12 | A14 | A16 |
| S1 | −4.3613E−03 | −1.0094E−02 | −3.9235E−03 | −9.4552E−04 | −8.7349E−05 | 6.5746E−05 | 4.4819E−05 |
| S2 | −7.5896E−02 | −3.5604E−03 | 3.6514E−03 | 1.6101E−03 | 3.7314E−04 | 7.3560E−05 | 2.9822E−05 |
| S3 | −6.6665E−02 | 1.4944E−02 | 3.4786E−03 | 7.9046E−04 | 1.3948E−04 | −4.1515E−06 | 1.0430E−05 |
| S4 | −2.6039E−02 | 2.8749E−03 | −2.4669E−03 | −1.7953E−03 | −7.3604E−04 | −2.2193E−04 | 3.5452E−05 |
| S5 | 3.4418E−02 | 9.8499E−03 | 4.6180E−03 | 6.1972E−04 | −2.7473E−04 | −2.6394E−04 | −4.0789E−05 |
| S6 | 4.9613E−03 | 6.7535E−03 | 3.9396E−03 | 1.7425E−03 | 6.7872E−04 | 2.4928E−04 | 9.4465E−05 |
| S7 | −1.9317E−01 | −2.4074E−02 | −1.8223E−03 | 4.4605E−04 | 2.7206E−04 | 5.1752E−05 | −1.9406E−05 |
| S8 | −3.1493E−01 | −3.0584E−03 | 1.2079E−02 | 6.4659E−03 | 7.4957E−04 | −2.7975E−04 | −3.0248E−04 |
| S9 | −3.5499E−01 | 2.1703E−02 | −2.8815E−02 | 5.2464E−04 | 3.1298E−03 | 2.2869E−03 | 1.1442E−03 |
| S10 | −4.4456E−01 | 1.1773E−01 | −7.4177E−02 | 5.7956E−03 | 4.8518E−03 | −3.5989E−03 | −1.0855E−03 |
| S11 | −1.3866E+00 | 2.6218E−01 | 3.0089E−02 | −5.3912E−02 | 6.2905E−03 | 9.0617E−03 | −4.3035E−03 |
| S12 | −2.9634E−01 | 9.9264E−02 | 4.4270E−02 | −4.1948E−02 | 1.6989E−02 | 1.1712E−03 | −3.7909E−03 |
| S13 | −8.4626E−01 | 6.5138E−01 | −3.1188E−01 | 1.3427E−01 | −4.0146E−02 | 1.2933E−02 | −4.4956E−03 |
| S14 | −4.5787E+00 | 9.3717E−01 | −3.3732E−01 | 1.7713E−01 | −7.1399E−02 | 2.5472E−02 | −1.7270E−02 |

TABLE 10-2

| Surface | | | | | | | |
|---|---|---|---|---|---|---|---|
| number | A18 | A20 | A22 | A24 | A26 | A28 | A30 |
| S1 | 1.4059E−05 | −3.0235E−06 | 0.0000E+00 | 0.0000E+00 | 0.0000E+00 | 0.0000E+00 | 0.0000E+00 |
| S2 | 3.5534E−05 | 1.6518E−05 | 0.0000E+00 | 0.0000E+00 | 0.0000E+00 | 0.0000E+00 | 0.0000E+00 |
| S3 | 2.9073E−05 | 1.0818E−05 | 0.0000E+00 | 0.0000E+00 | 0.0000E+00 | 0.0000E+00 | 0.0000E+00 |
| S4 | 8.8306E−05 | 4.9046E−05 | 0.0000E+00 | 0.0000E+00 | 0.0000E+00 | 0.0000E+00 | 0.0000E+00 |
| S5 | 3.9546E−05 | 4.4419E−05 | 0.0000E+00 | 0.0000E+00 | 0.0000E+00 | 0.0000E+00 | 0.0000E+00 |
| S6 | 3.7881E−05 | 1.2615E−05 | 0.0000E+00 | 0.0000E+00 | 0.0000E+00 | 0.0000E+00 | 0.0000E+00 |
| S7 | −2.7349E−05 | −1.2232E−05 | 4.1312E−08 | 0.0000E+00 | 0.0000E+00 | 0.0000E+00 | 0.0000E+00 |
| S8 | −1.6799E−04 | −2.8910E−05 | 0.0000E+00 | 0.0000E+00 | 0.0000E+00 | 0.0000E+00 | 0.0000E+00 |
| S9 | 3.3064E−04 | 2.0184E−04 | −9.4920E−05 | −7.0620E−05 | −5.9592E−05 | 0.0000E+00 | 0.0000E+00 |
| S10 | 8.8111E−04 | 2.1660E−04 | −2.1351E−04 | 1.8804E−04 | 1.0367E−04 | 0.0000E+00 | 0.0000E+00 |
| S11 | −4.0023E−03 | 1.5092E−03 | 7.1183E−04 | −6.7882E−04 | −2.2279E−04 | 1.3286E−04 | 5.3299E−05 |
| S12 | −4.4032E−03 | −1.2583E−04 | 1.6267E−03 | 8.5548E−04 | 1.6007E−04 | −2.5285E−04 | −2.4960E−04 |
| S13 | −2.0987E−03 | −9.9310E−04 | 3.0989E−03 | −5.2653E−04 | −4.0838E−04 | 1.1168E−04 | −7.7340E−05 |
| S14 | 8.5332E−03 | −1.6311E−03 | 4.3819E−03 | −6.1634E−04 | 8.0681E−04 | −6.4419E−04 | 3.2492E−05 |

FIG. 10A shows a longitudinal aberration curve of the optical imaging lens assembly according to embodiment 5 to represent deviation of a convergence focal point after light with different wavelengths passes through the lens. FIG. 10B shows an astigmatism curve of the optical imaging lens assembly according to embodiment 5 to represent a tangential image surface curvature and a sagittal image surface curvature. FIG. 10C shows a distortion curve of the optical imaging lens assembly according to embodiment 5 to represent distortion values corresponding to different image heights. FIG. 10D shows a lateral color curve of the optical imaging lens assembly according to embodiment 5 to represent deviation of different image heights on the imaging surface after the light passes through the lens. According to FIG. 10A to FIG. 10D, it can be seen that the optical imaging lens assembly provided in embodiment 5 may achieve high imaging quality.

### Embodiment 6

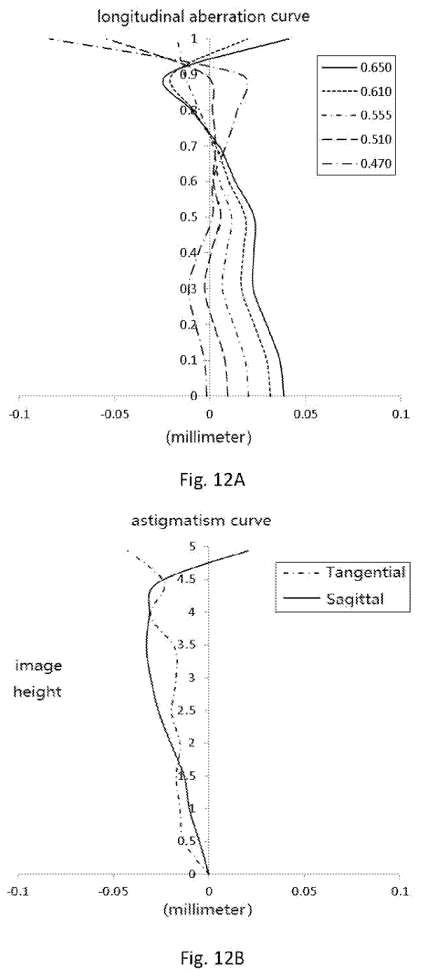

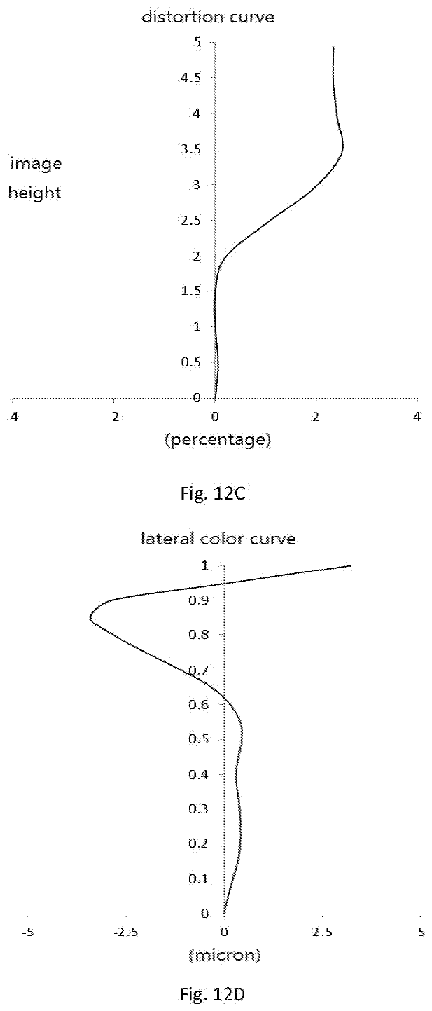

An optical imaging lens assembly according to embodiment 6 of the disclosure is described below with reference to FIG. 11 to FIG. 12D. FIG. 11 is a structure diagram of an optical imaging lens assembly according to embodiment 6 of the disclosure.

As shown in FIG. 11, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a negative refractive power, an object-side surface S7 thereof is a concave surface, while an image-side surface S8 is a convex surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.92 mm, a TTL of the optical imaging lens assembly is 5.60 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.6°, and a ratio f/EPD of the total effective focal length f of the optical imaging lens assembly to an EPD of the optical imaging lens assembly is 1.80.

Table 11 is a basic parameter table of the optical imaging lens assembly of embodiment 6, and units of the curvature radius, the thickness/distance and the focal length are all millimeter (mm). Tables 12-1 and 12-2 show high-order coefficients applied to each aspheric mirror surface in embodiment 6. A surface type of each aspheric surface may be defined by formula (1) given in embodiment 1.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.5640 | | | | |
| S1 | Aspheric | 1.8096 | 0.6930 | 1.55 | 56.1 | 5.99 | −0.2337 |
| S2 | Aspheric | 3.5061 | 0.1209 | | | | 0.1992 |
| S3 | Aspheric | 5.3683 | 0.2500 | 1.67 | 19.2 | −16.14 | 1.9728 |
| S4 | Aspheric | 3.5333 | 0.0300 | | | | 3.1946 |
| S5 | Aspheric | 4.3528 | 0.4526 | 1.55 | 56.1 | 9.49 | 5.3011 |
| S6 | Aspheric | 26.1785 | 0.3467 | | | | −8.9195 |
| S7 | Aspheric | −22.4996 | 0.3440 | 1.67 | 19.2 | −39.11 | −30.8011 |
| S8 | Aspheric | −150.0000 | 0.1378 | | | | −99.0000 |
| S9 | Aspheric | 122.0718 | 0.3000 | 1.57 | 38.0 | −146.49 | 99.0000 |
| S10 | Aspheric | 49.5590 | 0.4007 | | | | −87.9233 |
| S11 | Aspheric | 4.5109 | 0.6000 | 1.55 | 56.1 | 5.77 | 0.0388 |
| S12 | Aspheric | −9.9688 | 0.5846 | | | | 0.6022 |
| S13 | Aspheric | −6.8244 | 0.4500 | 1.54 | 55.9 | −2.99 | −0.1392 |
| S14 | Aspheric | 2.1509 | 0.3064 | | | | −0.9906 |
| S15 | Spherical | Infinite | 0.2100 | 1.52 | 64.2 | | |
| S16 | Spherical | Infinite | 0.3733 | | | | |
| S17 | Spherical | Infinite | | | | | |

TABLE 12-1

| Surface | | | | | | | |
|---|---|---|---|---|---|---|---|
| number | A4 | A6 | A8 | A10 | A12 | A14 | A16 |
| S1 | −5.1125E−03 | −1.0677E−02 | −4.1156E−03 | −9.4788E−04 | −6.0802E−05 | 9.1008E−05 | 5.8688E−05 |
| S2 | −7.6578E−02 | −3.4272E−03 | 3.8470E−03 | 1.9754E−03 | 6.2378E−04 | 1.7162E−04 | 7.5350E−05 |
| S3 | −6.6563E−02 | 1.4954E−02 | 3.4742E−03 | 1.1621E−03 | 3.4121E−04 | 3.6598E−05 | 3.1241E−05 |
| S4 | −2.7505E−02 | 2.3434E−03 | −3.2895E−03 | −2.1078E−03 | −7.3664E−04 | −2.8090E−04 | 5.4841E−05 |
| S5 | 3.3605E−02 | 1.1258E−02 | 4.8388E−03 | 4.2096E−04 | −2.9338E−04 | −3.6006E−04 | −6.0069E−05 |
| S6 | 5.2602E−03 | 6.6263E−03 | 4.3234E−03 | 1.8639E−03 | 7.5194E−04 | 2.7932E−04 | 1.1069E−04 |
| S7 | −1.8732E−01 | −2.5255E−02 | −1.2685E−03 | 5.8970E−04 | 4.3048E−04 | 1.1690E−04 | 1.9066E−05 |
| S8 | −2.9592E−01 | −3.4349E−03 | 1.3409E−02 | 5.8950E−03 | 8.6690E−04 | −3.7582E−04 | −4.5944E−04 |
| S9 | −3.3452E−01 | 2.1500E−02 | −2.9068E−02 | −9.7288E−04 | 3.2199E−03 | 2.0533E−03 | 8.9253E−04 |
| S10 | −4.3307E−01 | 1.1741E−01 | −7.3148E−02 | 4.9404E−03 | 4.7529E−03 | −3.4002E−03 | −1.0367E−03 |
| S11 | −1.3866E+00 | 2.6201E−01 | 2.7852E−02 | −5.2705E−02 | 6.0652E−03 | 8.7938E−03 | −4.3473E−03 |
| S12 | −2.9658E−01 | 9.9751E−02 | 4.4380E−02 | −4.2227E−02 | 1.7061E−02 | 1.1384E−03 | −3.8820E−03 |
| S13 | −8.4646E−01 | 6.5102E−01 | −3.1298E−01 | 1.3503E−01 | −4.0538E−02 | 1.2971E−02 | −4.5621E−03 |
| S14 | −4.6058E+00 | 9.4370E−01 | −3.4417E−01 | 1.7890E−01 | −7.3110E−02 | 2.5662E−02 | −1.7233E−02 |

TABLE 12-2

| Surface | | | | | | | |
|---|---|---|---|---|---|---|---|
| number | A18 | A20 | A22 | A24 | A26 | A28 | A30 |
| S1 | 2.2408E−05 | −3.3601E−06 | 0.0000E+00 | 0.0000E+00 | 0.0000E+00 | 0.0000E+00 | 0.0000E+00 |
| S2 | 5.3896E−05 | 2.4395E−05 | 0.0000E+00 | 0.0000E+00 | 0.0000E+00 | 0.0000E+00 | 0.0000E+00 |
| S3 | 3.1373E−05 | 1.2495E−05 | 0.0000E+00 | 0.0000E+00 | 0.0000E+00 | 0.0000E+00 | 0.0000E+00 |
| S4 | 1.0439E−04 | 6.2991E−05 | 0.0000E+00 | 0.0000E+00 | 0.0000E+00 | 0.0000E+00 | 0.0000E+00 |
| S5 | 3.3756E−05 | 5.0267E−05 | 0.0000E+00 | 0.0000E+00 | 0.0000E+00 | 0.0000E+00 | 0.0000E+00 |
| S6 | 4.3787E−05 | 1.4025E−05 | 0.0000E+00 | 0.0000E+00 | 0.0000E+00 | 0.0000E+00 | 0.0000E+00 |
| S7 | −1.3061E−05 | −2.3609E−06 | 0.0000E+00 | 0.0000E+00 | 0.0000E+00 | 0.0000E+00 | 0.0000E+00 |
| S8 | −2.4901E−04 | −4.9461E−05 | 0.0000E+00 | 0.0000E+00 | 0.0000E+00 | 0.0000E+00 | 0.0000E+00 |
| S9 | 4.0596E−04 | 2.8399E−04 | −4.1637E−05 | −4.8200E−05 | −4.0125E−05 | 0.0000E+00 | 0.0000E+00 |
| S10 | 8.9009E−04 | 2.1256E−04 | −1.9519E−04 | 1.8775E−04 | 1.0374E−04 | 0.0000E+00 | 0.0000E+00 |
| S11 | −3.9448E−03 | 1.5970E−03 | 7.3100E−04 | −6.6170E−04 | −2.0166E−04 | 1.6581E−04 | 7.2395E−05 |
| S12 | −4.3841E−03 | −2.6264E−05 | 1.6723E−03 | 8.7410E−04 | 1.6139E−04 | −2.7701E−04 | −2.5014E−04 |
| S13 | −2.0990E−03 | −8.8968E−04 | 3.1545E−03 | −5.4750E−04 | −4.1566E−04 | 1.1210E−04 | −9.5272E−05 |
| S14 | 8.9367E−03 | −1.6501E−03 | 4.3463E−03 | −6.6782E−04 | 8.0209E−04 | −6.5440E−04 | 4.0683E−05 |

FIG. 12A shows a longitudinal aberration curve of the optical imaging lens assembly according to embodiment 6 to represent deviation of a convergence focal point after light with different wavelengths passes through the lens. FIG. 12B shows an astigmatism curve of the optical imaging lens assembly according to embodiment 6 to represent a tangential image surface curvature and a sagittal image surface curvature. FIG. 12C shows a distortion curve of the optical imaging lens assembly according to embodiment 6 to represent distortion values corresponding to different image heights. FIG. 12D shows a lateral color curve of the optical imaging lens assembly according to embodiment 6 to represent deviation of different image heights on the imaging surface after the light passes through the lens. According to FIG. 12A to FIG. 12D, it can be seen that the optical imaging lens assembly provided in embodiment 6 may achieve high imaging quality.

### Embodiment 7

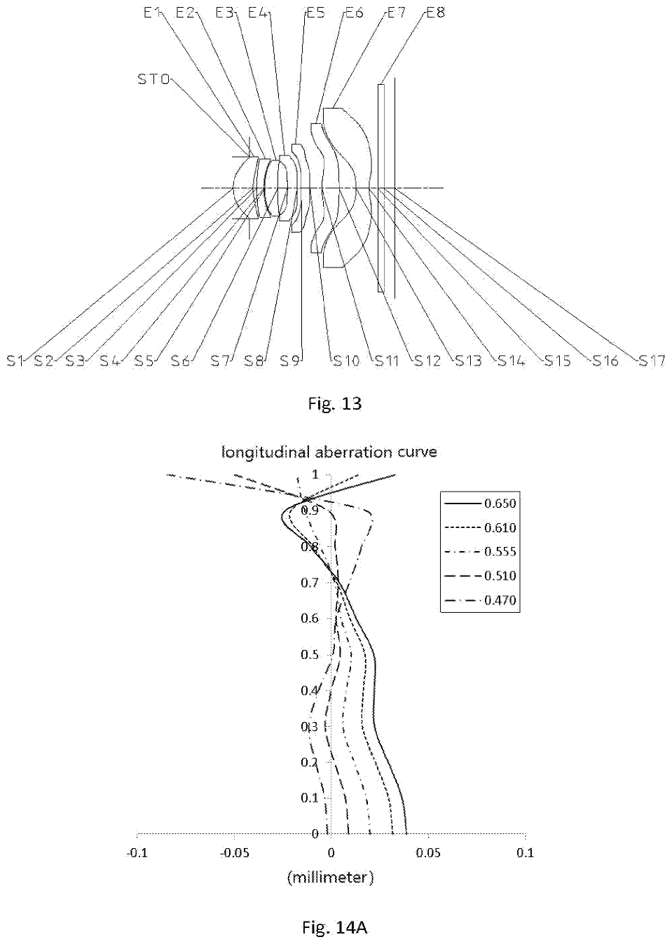

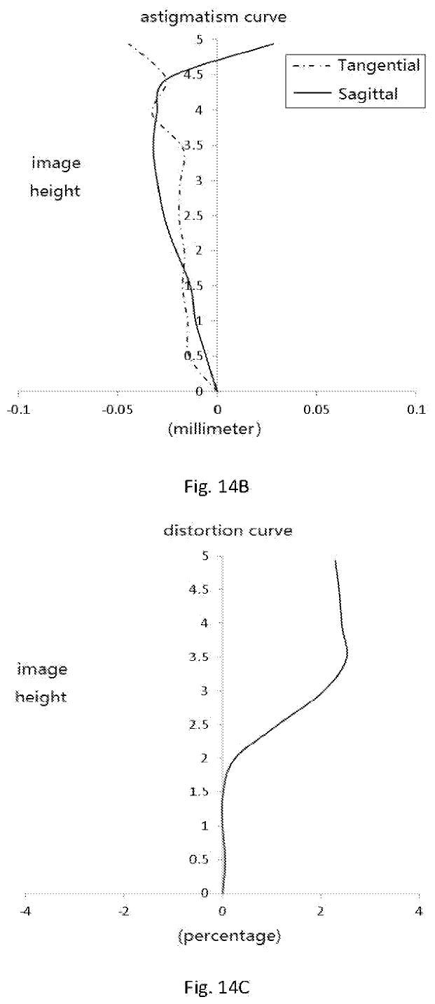

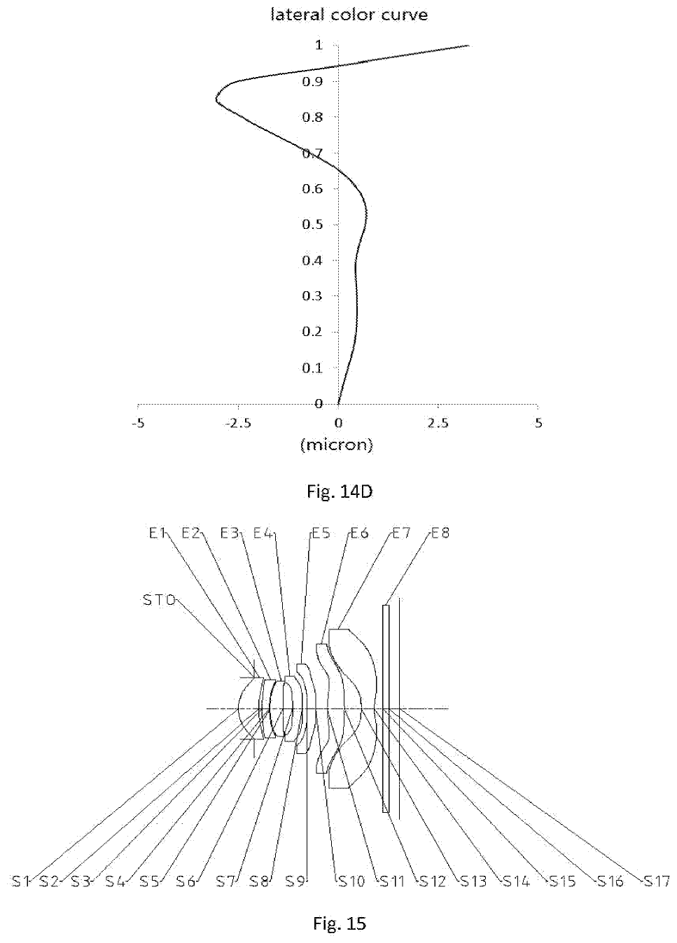

An optical imaging lens assembly according to embodiment 7 of the disclosure is described below with reference to FIG. 13 to FIG. 14D. FIG. 13 is a structure diagram of an optical imaging lens assembly according to embodiment 7 of the disclosure.

As shown in FIG. 13, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a negative refractive power, an object-side surface S7 thereof is a concave surface, while an image-side surface S8 is a concave surface. The fifth lens E5 has a negative refractive power, an object-side surface S9 thereof is a convex surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.92 mm, a TTL of the optical imaging lens assembly is 5.60 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.6°, and a ratio f/EPD of the total effective focal length f of the optical imaging lens assembly to an EPD of the optical imaging lens assembly is 1.80.

Table 13 is a basic parameter table of the optical imaging lens assembly of embodiment 7, and units of the curvature radius, the thickness/distance and the focal length are all millimeter (mm). Tables 14-1 and 14-2 show high-order coefficients applied to each aspheric mirror surface in embodiment 7. A surface type of each aspheric surface may be defined by formula (1) given in embodiment 1.

TABLE 13

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| STO | Spherical | Infinite | −0.5610 | | | | |
| S1 | Aspheric | 1.8116 | 0.6959 | 1.55 | 56.1 | 6.00 | −0.2394 |
| S2 | Aspheric | 3.5019 | 0.1216 | | | | 0.0000 |
| S3 | Aspheric | 5.5061 | 0.2500 | 1.67 | 19.2 | −16.37 | 1.5533 |
| S4 | Aspheric | 3.6119 | 0.0300 | | | | 3.3461 |
| S5 | Aspheric | 4.3924 | 0.4489 | 1.55 | 56.1 | 9.75 | 5.3743 |
| S6 | Aspheric | 24.2406 | 0.3395 | | | | −13.6830 |
| S7 | Aspheric | −38.1595 | 0.3411 | 1.67 | 19.2 | −38.31 | −99.0000 |
| S8 | Aspheric | 81.4583 | 0.1413 | | | | 99.0000 |
| S9 | Aspheric | 43.7075 | 0.3000 | 1.57 | 38.0 | −200.00 | 85.9654 |
| S10 | Aspheric | 31.5215 | 0.4057 | | | | −97.6088 |
| S11 | Aspheric | 4.4872 | 0.6000 | 1.55 | 56.1 | 5.76 | 0.0629 |
| S12 | Aspheric | −10.0204 | 0.5873 | | | | 0.5384 |
| S13 | Aspheric | −6.8255 | 0.4500 | 1.54 | 55.9 | −3.01 | −0.1255 |
| S14 | Aspheric | 2.1617 | 0.3059 | | | | −0.9887 |
| S15 | Spherical | Infinite | 0.2100 | 1.52 | 64.2 | | |
| S16 | Spherical | Infinite | 0.3728 | | | | |
| S17 | Spherical | Infinite | | | | | |

TABLE 14-1

| Surface | | | | | | | |
|---|---|---|---|---|---|---|---|
| number | A4 | A6 | A8 | A10 | A12 | A14 | A16 |
| S1 | −6.0456E−03 | −1.1041E−02 | −4.2058E−03 | −9.7386E−04 | −6.1961E−05 | 8.8165E−05 | 5.7008E−05 |
| S2 | −8.0831E−02 | −3.6909E−03 | 3.8786E−03 | 1.8361E−03 | 5.0089E−04 | 1.1769E−04 | 5.3939E−05 |
| S3 | −6.7896E−02 | 1.5417E−02 | 3.4512E−03 | 1.0051E−03 | 2.4424E−04 | 4.1653E−06 | 2.0270E−05 |
| S4 | −2.6563E−02 | 2.6411E−03 | −3.1096E−03 | −2.0462E−03 | −7.3797E−04 | −2.7207E−04 | 4.7957E−05 |
| S5 | 3.4118E−02 | 1.0846E−02 | 4.9351E−03 | 5.1500E−04 | −2.7328E−04 | −3.3904E−04 | −5.9048E−05 |
| S6 | 5.4156E−03 | 6.7497E−03 | 4.3007E−03 | 1.8541E−03 | 7.4206E−04 | 2.7277E−04 | 1.0687E−04 |
| S7 | −1.8951E−01 | −2.5032E−02 | −1.4381E−03 | 5.4507E−04 | 3.7303E−04 | 9.5867E−05 | −8.8393E−07 |
| S8 | −3.0211E−01 | −3.5056E−03 | 1.3215E−02 | 5.9022E−03 | 8.0366E−04 | −3.8601E−04 | −4.1336E−04 |
| S9 | −3.4320E−01 | 2.2094E−02 | −2.8985E−02 | −5.5780E−04 | 3.3186E−03 | 2.0505E−03 | 9.6111E−04 |
| S10 | −4.4149E−01 | 1.1825E−01 | −7.3759E−02 | 5.4092E−03 | 4.7345E−03 | −3.4885E−03 | −1.0021E−03 |
| S11 | −1.3888E+00 | 2.6166E−01 | 2.8755E−02 | −5.3392E−02 | 6.1700E−03 | 8.9969E−03 | −4.3288E−03 |
| S12 | −2.9582E−01 | 9.8903E−02 | 4.4302E−02 | −4.2015E−02 | 1.7022E−02 | 1.1862E−03 | −3.8031E−03 |
| S13 | −8.4805E−01 | 6.5083E−01 | −3.1206E−01 | 1.3423E−01 | −4.0192E−02 | 1.2932E−02 | −4.4825E−03 |
| S14 | −4.5896E+00 | 9.4181E−01 | −3.4021E−01 | 1.7831E−01 | −7.3368E−02 | 2.5433E−02 | −1.7202E−02 |

TABLE 14-2

| Surface | | | | | | | |
|---|---|---|---|---|---|---|---|
| number | A18 | A20 | A22 | A24 | A26 | A28 | A30 |
| S1 | 1.9865E−05 | −3.0643E−06 | 0.0000E+00 | 0.0000E+00 | 0.0000E+00 | 0.0000E+00 | 0.0000E+00 |
| S2 | 4.6506E−05 | 2.2293E−05 | 0.0000E+00 | 0.0000E+00 | 0.0000E+00 | 0.0000E+00 | 0.0000E+00 |
| S3 | 3.1587E−05 | 1.3998E−05 | 0.0000E+00 | 0.0000E+00 | 0.0000E+00 | 0.0000E+00 | 0.0000E+00 |
| S4 | 9.7719E−05 | 6.0300E−05 | 0.0000E+00 | 0.0000E+00 | 0.0000E+00 | 0.0000E+00 | 0.0000E+00 |
| S5 | 2.9682E−05 | 4.8334E−05 | 0.0000E+00 | 0.0000E+00 | 0.0000E+00 | 0.0000E+00 | 0.0000E+00 |
| S6 | 4.1503E−05 | 1.3342E−05 | 0.0000E+00 | 0.0000E+00 | 0.0000E+00 | 0.0000E+00 | 0.0000E+00 |
| S7 | −1.7848E−05 | −7.9156E−06 | 4.0237E−08 | 0.0000E+00 | 0.0000E+00 | 0.0000E+00 | 0.0000E+00 |
| S8 | −2.1365E−04 | −3.8353E−05 | 0.0000E+00 | 0.0000E+00 | 0.0000E+00 | 0.0000E+00 | 0.0000E+00 |
| S9 | 3.7940E−04 | 2.4907E−04 | −7.3345E−05 | −5.9578E−05 | −5.0131E−05 | 0.0000E+00 | 0.0000E+00 |
| S10 | 8.8525E−04 | 1.9398E−04 | −1.9504E−04 | 1.9164E−04 | 9.9713E−05 | 0.0000E+00 | 0.0000E+00 |
| S11 | −4.0218E−03 | 1.5917E−03 | 7.4203E−04 | −6.8023E−04 | −2.1331E−04 | 1.6588E−04 | 6.7207E−05 |
| S12 | −4.3921E−03 | −8.8667E−05 | 1.6317E−03 | 8.6056E−04 | 1.7240E−04 | −2.5668E−04 | −2.5180E−04 |
| S13 | −2.1199E−03 | −9.7890E−04 | 3.1279E−03 | −5.0893E−04 | −4.0562E−04 | 1.1399E−04 | −9.1413E−05 |
| S14 | 8.8853E−03 | −1.5996E−03 | 4.3222E−03 | −6.7996E−04 | 7.7359E−04 | −6.4287E−04 | 4.8229E−05 |

FIG. 14A shows a longitudinal aberration curve of the optical imaging lens assembly according to embodiment 7 to represent deviation of a convergence focal point after light with different wavelengths passes through the lens. FIG. 14B shows an astigmatism curve of the optical imaging lens assembly according to embodiment 7 to represent a tangential image surface curvature and a sagittal image surface curvature. FIG. 14C shows a distortion curve of the optical imaging lens assembly according to embodiment 7 to represent distortion values corresponding to different image heights. FIG. 14D shows a lateral color curve of the optical imaging lens assembly according to embodiment 7 to represent deviation of different image heights on the imaging surface after the light passes through the lens. According to FIG. 14A to FIG. 14D, it can be seen that the optical imaging lens assembly provided in embodiment 7 may achieve high imaging quality.

### Embodiment 8

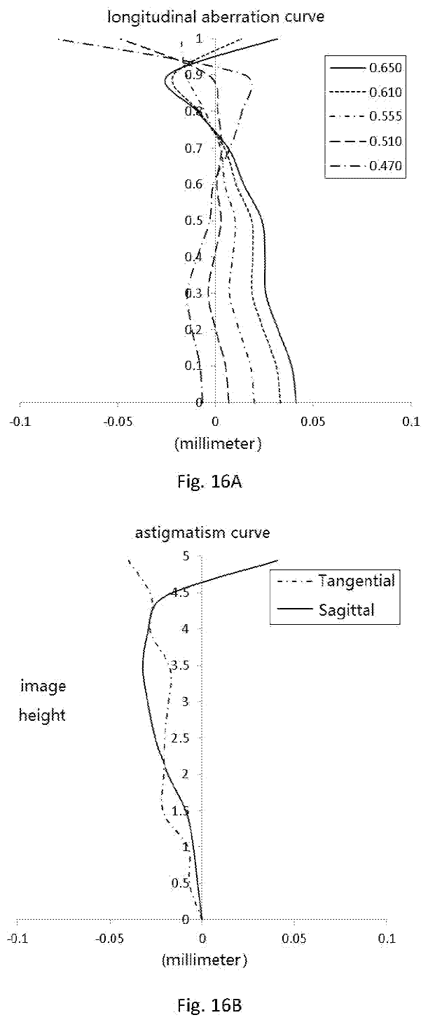

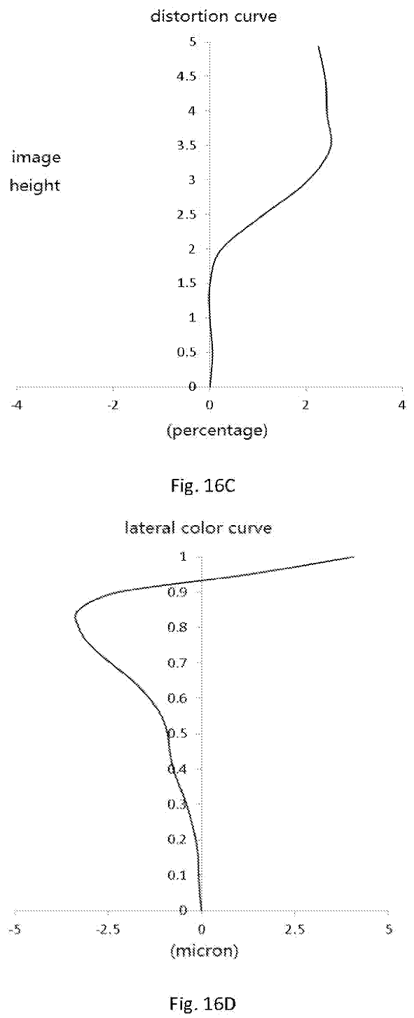

An optical imaging lens assembly according to embodiment 8 of the disclosure is described below with reference to FIG. 15 to FIG. 16D. FIG. 15 is a structure diagram of an optical imaging lens assembly according to embodiment 8 of the disclosure.

As shown in FIG. 15, the optical imaging lens assembly sequentially includes, from an object side to an image side, a diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a concave surface. The fourth lens E4 has a positive refractive power, an object-side surface S7 thereof is a concave surface, while an image-side surface S8 is a convex surface. The fifth lens E5 has a negative refractive power, an object-side surface S9 thereof is a concave surface, while an image-side surface S10 is a concave surface. The sixth lens E6 has a positive refractive power, an object-side surface S11 thereof is a convex surface, while an image-side surface S12 is a convex surface. The seventh lens E7 has a negative refractive power, an object-side surface S13 thereof is a concave surface, while an image-side surface S14 is a concave surface. The optical filter E8 has an object-side surface S15 and an image-side surface S16. Light from an object sequentially penetrates through each of the surfaces S1 to S16 and is finally imaged on the imaging surface S17.

In the example, a total effective focal length f of the optical imaging lens assembly is 4.92 mm, a TTL of the optical imaging lens assembly is 5.60 mm, ImgH is a half of a diagonal length of an effective pixel region on the imaging surface S17 of the optical imaging lens assembly, ImgH is 4.79 mm, Semi-FOV is a half of a maximum field of view of the optical imaging lens assembly, Semi-FOV is 43.7°, and a ratio f/EPD of the total effective focal length f of the optical imaging lens assembly to an EPD of the optical imaging lens assembly is 1.80.

Table 15 is a basic parameter table of the optical imaging lens assembly of embodiment 8, and units of the curvature radius, the thickness/distance and the focal length are all millimeter (mm). Tables 16-1 and 16-2 show high-order coefficients applied to each aspheric mirror surface in embodiment 8. A surface type of each aspheric surface may be defined by formula (1) given in embodiment 1.

TABLE 15

| | | | | Material | | | |
|---|---|---|---|---|---|---|---|
| Surface | | Curvature | Thickness/ | Refractive | Abbe | Focal | Conic |
| number | Surface type | radius | distance | index | number | length | coefficient |
| OBJ | Spherical | Infinite | Infinite | | | | |
| STO | Spherical | Infinite | −0.5573 | | | | |
| S1 | Aspheric | 1.8170 | 0.7004 | 1.55 | 56.1 | 5.98 | −0.2462 |
| S2 | Aspheric | 3.5410 | 0.1212 | | | | 0.0000 |
| S3 | Aspheric | 5.6968 | 0.2500 | 1.67 | 19.2 | −15.74 | 1.3474 |
| S4 | Aspheric | 3.6473 | 0.0300 | | | | 3.3995 |
| S5 | Aspheric | 4.3240 | 0.4463 | 1.55 | 56.1 | 10.06 | 4.6430 |
| S6 | Aspheric | 19.6310 | 0.3297 | | | | −99.0000 |
| S7 | Aspheric | −49.1259 | 0.3416 | 1.67 | 19.2 | 400.00 | −42.1551 |
| S8 | Aspheric | −41.7046 | 0.1676 | | | | −99.0000 |
| S9 | Aspheric | −66.6789 | 0.3000 | 1.57 | 38.0 | −35.17 | −99.0000 |
| S10 | Aspheric | 28.7412 | 0.3950 | | | | −99.0000 |
| S11 | Aspheric | 4.5141 | 0.6000 | 1.55 | 56.1 | 5.76 | 0.0735 |
| S12 | Aspheric | −9.8893 | 0.5792 | | | | 0.5613 |
| S13 | Aspheric | −6.8565 | 0.4500 | 1.54 | 55.9 | −3.00 | −0.0634 |
| S14 | Aspheric | 2.1566 | 0.3060 | | | | −0.9872 |
| S15 | Spherical | Infinite | 0.2100 | 1.52 | 64.2 | | |
| S16 | Spherical | Infinite | 0.3729 | | | | |
| S17 | Spherical | Infinite | | | | | |

TABLE 16-1

| Surface | | | | | | | |
|---|---|---|---|---|---|---|---|
| number | A4 | A6 | A8 | A10 | A12 | A14 | A16 |
| S1 | −7.2769E−03 | −1.0894E−02 | −3.8765E−03 | −8.1940E−04 | 1.6546E−05 | 1.0412E−04 | 6.0564E−05 |
| S2 | −8.7171E−02 | −2.9953E−03 | 4.3110E−03 | 1.8677E−03 | 4.6889E−04 | 1.0299E−04 | 4.3851E−05 |
| S3 | −6.8005E−02 | 1.4394E−02 | 3.2176E−03 | 8.4446E−04 | 1.3771E−04 | −4.6514E−05 | 1.9665E−06 |
| S4 | −2.6354E−02 | 1.1336E−03 | −4.0212E−03 | −2.3193E−03 | −8.3000E−04 | −3.1099E−04 | 5.8525E−05 |
| S5 | 2.9752E−02 | 1.1133E−02 | 4.9225E−03 | 4.3419E−04 | −3.5074E−04 | −4.1803E−04 | −7.7706E−05 |
| S6 | 1.0599E−03 | 6.1310E−03 | 4.4074E−03 | 1.9987E−03 | 7.8111E−04 | 3.0925E−04 | 1.0892E−04 |
| S7 | −1.8333E−01 | −2.6039E−02 | −1.5095E−03 | 5.3658E−04 | 3.3744E−04 | 6.7150E−05 | −4.0350E−05 |
| S8 | −2.5963E−01 | −2.0488E−03 | 1.5046E−02 | 5.0733E−03 | 8.6414E−04 | −4.8125E−04 | −3.1966E−04 |
| S9 | −3.2351E−01 | 2.5024E−02 | −2.5897E−02 | 1.5380E−03 | 5.6874E−03 | 2.6422E−03 | 1.0375E−03 |
| S10 | −4.6185E−01 | 1.2173E−01 | −7.5188E−02 | 4.5788E−03 | 4.5991E−03 | −3.2503E−03 | −8.8227E−04 |
| S11 | −1.3971E+00 | 2.6965E−01 | 2.7845E−02 | −5.5716E−02 | 7.1144E−03 | 9.1786E−03 | −4.6850E−03 |
| S12 | −2.9732E−01 | 1.0213E−01 | 4.4024E−02 | −4.1871E−02 | 1.7149E−02 | 1.0235E−03 | −3.7096E−03 |
| S13 | −8.4232E−01 | 6.5050E−01 | −3.1108E−01 | 1.3344E−01 | −4.0012E−02 | 1.2962E−02 | −4.4708E−03 |
| S14 | −4.5874E+00 | 9.5040E−01 | −3.3692E−01 | 1.7891E−01 | −7.4676E−02 | 2.5570E−02 | −1.7394E−02 |

TABLE 16-2

| Surface | | | | | | | |
|---|---|---|---|---|---|---|---|
| number | A18 | A20 | A22 | A24 | A26 | A28 | A30 |
| S1 | 1.6048E−05 | −3.2766E−06 | 0.0000E+00 | 0.0000E+00 | 0.0000E+00 | 0.0000E+00 | 0.0000E+00 |
| S2 | 4.2886E−05 | 2.0089E−05 | 0.0000E+00 | 0.0000E+00 | 0.0000E+00 | 0.0000E+00 | 0.0000E+00 |
| S3 | 2.4899E−05 | 1.1447E−05 | 0.0000E+00 | 0.0000E+00 | 0.0000E+00 | 0.0000E+00 | 0.0000E+00 |
| S4 | 1.1744E−04 | 6.9726E−05 | 0.0000E+00 | 0.0000E+00 | 0.0000E+00 | 0.0000E+00 | 0.0000E+00 |
| S5 | 3.2211E−05 | 5.5823E−05 | 0.0000E+00 | 0.0000E+00 | 0.0000E+00 | 0.0000E+00 | 0.0000E+00 |
| S6 | 4.6709E−05 | 1.0630E−05 | 0.0000E+00 | 0.0000E+00 | 0.0000E+00 | 0.0000E+00 | 0.0000E+00 |
| S7 | −3.2043E−05 | −2.5208E−05 | 3.9525E−08 | 0.0000E+00 | 0.0000E+00 | 0.0000E+00 | 0.0000E+00 |
| S8 | −1.8386E−04 | −2.1396E−05 | 0.0000E+00 | 0.0000E+00 | 0.0000E+00 | 0.0000E+00 | 0.0000E+00 |
| S9 | 1.2385E−04 | −3.6762E−05 | −2.5269E−04 | −1.4558E−04 | −5.7233E−05 | 0.0000E+00 | 0.0000E+00 |
| S10 | 8.5823E−04 | 3.0987E−04 | −1.0154E−04 | 1.7942E−04 | 1.0275E−04 | 0.0000E+00 | 0.0000E+00 |
| S11 | −4.2654E−03 | 1.8373E−03 | 7.2292E−04 | −7.7158E−04 | −1.9361E−04 | 1.9999E−04 | 5.5086E−05 |
| S12 | −4.5370E−03 | −1.0625E−04 | 1.5761E−03 | 8.5975E−04 | 2.1198E−04 | −2.4563E−04 | −2.7298E−04 |
| S13 | −2.0881E−03 | −1.0926E−03 | 3.0952E−03 | −4.8755E−04 | −4.0899E−04 | 1.4567E−04 | −1.0498E−04 |
| S14 | 8.9710E−03 | −1.7490E−03 | 4.1804E−03 | −7.6296E−04 | 7.5044E−04 | −6.1720E−04 | 6.8477E−05 |

FIG. 16A shows a longitudinal aberration curve of the optical imaging lens assembly according to embodiment 8 to represent deviation of a convergence focal point after light with different wavelengths passes through the lens. FIG. 16B shows an astigmatism curve of the optical imaging lens assembly according to embodiment 8 to represent a tangential image surface curvature and a sagittal image surface curvature. FIG. 16C shows a distortion curve of the optical imaging lens assembly according to embodiment 8 to represent distortion values corresponding to different image heights. FIG. 16D shows a lateral color curve of the optical imaging lens assembly according to embodiment 8 to represent deviation of different image heights on the imaging surface after the light passes through the lens. According to FIG. 16A to FIG. 16D, it can be seen that the optical imaging lens assembly provided in embodiment 8 may achieve high imaging quality.

From the above, embodiment 1 to embodiment 8 meet a relationship shown in Table 17 respectively.

TABLE 17

| Conditional expression/embodiment | 1 | 2 | 3 | 4 | 5 | 6 | 7 | 8 |
|---|---|---|---|---|---|---|---|---|
| TTL/ImgH | 1.20 | 1.19 | 1.20 | 1.17 | 1.17 | 1.17 | 1.17 | 1.17 |
| f × tan(Semi-FOV) (mm) | 4.73 | 4.69 | 4.68 | 4.71 | 4.69 | 4.69 | 4.69 | 4.69 |
| f1/(R1 + R2) | 0.90 | 1.04 | 1.12 | 1.02 | 1.14 | 1.13 | 1.13 | 1.12 |
| (R3 + R4)/f2 | −0.69 | −0.65 | −0.52 | −0.59 | −0.54 | −0.55 | −0.56 | −0.59 |
| R5/f3 | 0.58 | 0.47 | 0.46 | 0.56 | 0.43 | 0.46 | 0.45 | 0.43 |
| f/f123 | 0.99 | 0.98 | 0.98 | 1.02 | 0.98 | 1.01 | 1.00 | 0.98 |
| (f7-f6)/f67 | 0.77 | 0.81 | 0.83 | 0.85 | 0.85 | 0.86 | 0.85 | 0.86 |
| (R13 + R14)/(R11 + R12) | 0.89 | 0.97 | 0.94 | 0.83 | 0.84 | 0.86 | 0.84 | 0.87 |
| SAG72/SAG71 | 0.70 | 0.74 | 0.73 | 0.81 | 0.82 | 0.81 | 0.81 | 0.79 |
| (SAG41 + SAG42)/SAG62 | 0.90 | 0.89 | 0.91 | 0.87 | 0.77 | 0.86 | 0.83 | 0.80 |
| ET2/ET7 | 0.46 | 0.49 | 0.47 | 0.52 | 0.54 | 0.53 | 0.53 | 0.52 |
| ET5/ET6 | 0.76 | 0.84 | 0.86 | 0.78 | 0.79 | 0.80 | 0.80 | 0.82 |
| (CT1 + CT2 + CT3)/ | 0.99 | 1.02 | 0.98 | 1.04 | 1.02 | 1.03 | 1.03 | 1.03 |
| (CT5 + CT6 + CT7) | | | | | | | | |
| CT4/T34 | 0.94 | 0.93 | 0.89 | 1.01 | 1.00 | 0.99 | 1.00 | 1.04 |

The disclosure also provides an imaging device, of which an electronic photosensitive element may be a Charge Coupled Device (CCD) or a Complementary Metal Oxide Semiconductor (CMOS). The imaging device may be an independent imaging device such as a digital camera, and may also be an imaging module integrated into a mobile electronic device such as a mobile phone. The imaging device is provided with the abovementioned optical imaging lens assembly.

The above description is only description about the preferred embodiments of the disclosure and adopted technical principles. It is understood by those skilled in the art that the scope of disclosure involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1. An optical imaging lens assembly, sequentially comprising, from an object side to an image side along an optical axis, a first lens, a second lens, a third lens, a fourth lens, a fifth lens, a sixth lens and a seventh lens with refractive power respectively, wherein TTL is a distance from an object-side surface of the first lens to an imaging surface of the optical imaging lens assembly on the optical axis, and ImgH is a half of a diagonal length of an effective pixel region of the optical imaging lens assembly, TTL and ImgH meet TTL/ImgH≤1.2;
a total effective focal length f of the optical imaging lens assembly and an entrance pupil diameter (EPD) of the optical imaging lens assembly meet f/EPD≤1.8; and
Semi-FOV is a half of a maximum field of view (FOV) of the optical imaging lens assembly, the total effective focal length f of the optical imaging lens assembly and Semi-FOV meet f×tan(Semi-FOV)>4.6 mm.

2. The optical imaging lens assembly according to claim 1, wherein an effective focal length f1 of the first lens, a curvature radius R1 of the object-side surface of the first lens and a curvature radius R2 of an image-side surface of the first lens meet 0.8<f1/(R1+R2)<1.3.

3. The optical imaging lens assembly according to claim 1, wherein an effective focal length f2 of the second lens, a curvature radius R3 of an object-side surface of the second lens and a curvature radius R4 of an image-side surface of the second lens meet −1.0<(R3+R4)/f2<−0.5.

4. The optical imaging lens assembly according to claim 1, wherein an effective focal length f3 of the third lens and a curvature radius R5 of an object-side surface of the third lens meet 0.3<R5/f3<0.8.

5. The optical imaging lens assembly according to claim 1, wherein the total effective focal length f of the optical imaging lens assembly and a combined focal length f123 of the first lens, the second lens and the third lens meet 0.8<f/f123<1.3.

6. The optical imaging lens assembly according to claim 1, wherein an effective focal length f6 of the sixth lens, an effective focal length f7 of the seventh lens and a combined focal length f67 of the sixth lens and the seventh lens meet 0.5<(f7−f6)/f67<1.0.

7. The optical imaging lens assembly according to claim 1, wherein a curvature radius R11 of an object-side surface of the sixth lens, a curvature radius R12 of an image-side surface of the sixth lens, a curvature radius R13 of an object-side surface of the seventh lens and a curvature radius R14 of an image-side surface of the seventh lens meet 0.7<(R13+R14)/(R11+R12)<1.2.

8. The optical imaging lens assembly according to claim 1, wherein SAG71 is a distance from an intersection point of an object-side surface of the seventh lens and the optical axis to an effective radius vertex of the object-side surface of the seventh lens on the optical axis, and SAG72 is a distance from an intersection point of an image-side surface of the seventh lens and the optical axis to an effective radius vertex of the image-side surface of the seventh lens on the optical axis, SAG71 and SAG72 meet 0.5<SAG72/SAG71<1.0.

9. The optical imaging lens assembly according to claim 1, wherein SAG41 is a distance from an intersection point of an object-side surface of the fourth lens and the optical axis to an effective radius vertex of the object-side surface of the fourth lens on the optical axis, SAG42 is a distance from an intersection point of an image-side surface of the fourth lens and the optical axis to an effective radius vertex of the image-side surface of the fourth lens on the optical axis, and SAG62 is a distance from an intersection point of an image-side surface of the sixth lens and the optical axis to an effective radius vertex of the image-side surface of the sixth lens on the optical axis, SAG41 and SAG42 and SAG62 meet 0.7<(SAG41+SAG42)/SAG62<1.2.

10. The optical imaging lens assembly according to claim 1, wherein an edge thickness ET2 of the second lens and an edge thickness ET7 of the seventh lens may meet 0.3<ET2/ET7<0.8.

11. The optical imaging lens assembly according to claim 1, wherein an edge thickness ET5 of the fifth lens and an edge thickness ET6 of the sixth lens may meet 0.5<ET5/ET6<1.0.

12. The optical imaging lens assembly according to claim 1, wherein a center thickness CT1 of the first lens on the optical axis, a center thickness CT2 of the second lens on the optical axis, a center thickness CT3 of the third lens on the optical axis, a center thickness CT5 of the fifth lens on the optical axis, a center thickness CT6 of the sixth lens on the optical axis and a center thickness CT7 of the seventh lens on the optical axis may meet 0.8<(CT1+CT2+CT3)/(CT5+CT6+CT7)<1.3.

13. The optical imaging lens assembly according to claim 1, wherein a center thickness CT4 of the fourth lens on the optical axis and a spacing distance T34 of the third lens and the fourth lens on the optical axis may meet 0.7<CT4/T34<1.2.

14. The optical imaging lens assembly according to claim 1, wherein the first lens has a positive refractive power, the object-side surface thereof is a convex surface, while an image-side surface is a concave surface.

15. The optical imaging lens assembly according to claim 1, wherein the second lens has a negative refractive power, an object-side surface thereof is a convex surface, while an image-side surface is a concave surface.

16. The optical imaging lens assembly according to claim 1, wherein an object-side surface of the third lens is a convex surface.

17. The optical imaging lens assembly according to claim 1, wherein the sixth lens has a positive refractive power, and an object-side surface thereof is a convex surface.

18. The optical imaging lens assembly according to claim 1, wherein the seventh lens has a negative refractive power, an object-side surface thereof is a concave surface, while an image-side surface is a concave surface.

19. An optical imaging lens assembly, sequentially comprising, from an object side to an image side along an optical axis:
a first lens with a refractive power;
a second lens with a refractive power;
a third lens with a positive refractive power;
a fourth lens with a refractive power;
a fifth lens with a refractive power;
a sixth lens with a refractive power, an image-side surface thereof being a convex surface; and
a seventh lens with a refractive power, wherein
TTL is a distance from an object-side surface of the first lens to an imaging surface of the optical imaging lens assembly on the optical axis, and ImgH is a half of a diagonal length of an effective pixel region of the optical imaging lens assembly, TTL and ImgH meet TTL/ImgH≤1.2; and
a total effective focal length f of the optical imaging lens assembly and an entrance pupil diameter (EPD) of the optical imaging lens assembly meet f/EPED≤1.8.

20. The optical imaging lens assembly according to claim 19, wherein Semi-FOV is a half of a maximum field of view (FOV) of the optical imaging lens assembly, the total effective focal length f of the optical imaging lens assembly and Semi-FOV meet f×tan(Semi-FOV)>4.6 mm.
